(19) United States
(12) Patent Application Publication
(10) Pub. No.: US 2024/0318555 A1
(43) Pub. Date: Sep. 26, 2024

(54) STEAM TURBINE ROTOR BLADE EROSION AMOUNT MANAGING APPARATUS

(71) Applicant: TOSHIBA ENERGY SYSTEMS & SOLUTIONS CORPORATION, Kawasaki-shi (JP)

(72) Inventors: Yasuteru KAWAI, Yokohama Kanagawa (JP); Tsukasa TAKEUCHI, Yokohama Kanagawa (JP); Tomohiko TSUKUDA, Yokohama Kanagawa (JP); Yasunori ONO, Yokohama Kanagawa (JP); Tetsuya MAKINO, Kawasaki Kanagawa (JP); Hiroyuki ICHIKAWA, Koganei Tokyo (JP)

(73) Assignee: TOSHIBA ENERGY SYSTEMS & SOLUTIONS CORPORATION, Kawasaki-shi (JP)

(21) Appl. No.: 18/402,943

(22) Filed: Jan. 3, 2024

(30) Foreign Application Priority Data
Mar. 22, 2023 (JP) 2023-045646

(51) Int. Cl. F01D 5/00

(52) U.S. Cl. CPC F01D 5/005; F05D 2260/80; F05D 2260/821

(57) ABSTRACT

An erosion amount managing apparatus in an embodiment includes a display information generation section configured to generate display information for displaying: past erosion amount related information indicating information on a past erosion amount of a rotor blade of a steam turbine from the past to the present calculated based on measured information; and future erosion amount related information indicating information on a future erosion amount of the rotor blade calculated based on a future operating condition input via a user interface screen and the past erosion amount related information.

### CROSS REFERENCE TO RELATED APPLICATIONS

This application is based upon and claims the benefit of priority from Japanese Patent Application No. 2023-045646, filed on Mar. 22, 2023; the entire contents of which are incorporated herein by reference.

### FIELD

Embodiments described herein relate generally to a steam turbine rotor blade erosion amount managing apparatus.

### BACKGROUND

In the low-pressure turbine stages in a steam turbine, some of the steam may condense into water droplets. These water droplets collide with a rotor blade of the steam turbine, to thereby erode the rotor blade. Among the low-pressure turbine stages, the rotor blades in the final stage are susceptible to erosion by the water droplets.

This rotor blade erosion caused by water droplets, or erosion, has been periodically inspected every few years. During this periodic inspection, when the amount of erosion (erosion amount) in the erosion exceeds a reference value specified by a manufacturer of the rotor blade, the replacement of the rotor blade is recommended.

In recent years, the introduction of renewable energy has been accelerated in power generation facilities as a measure to reduce carbon dioxide (CO₂) emissions. In power generation using renewable energy, the amount of power generated varies depending on the weather or other factors. Therefore, in recent years, thermal power generation facilities have shifted to the operation mainly with regulated thermal power in order to compensate for the unstable power supply in the power generation using renewable energy.

As described above, the thermal power generation facilities including steam turbines are shifting from the operation mainly with a rated load to the operation mainly with a regulated load, and thus, there is a risk that the erosion will further develop in the steam turbine.

A user who manages a steam turbine in a thermal power generation facility can learn the erosion amount of the rotor blade during a periodic inspection. However, in a conventional steam turbine management system, the user is not able to learn information on the predicted erosion amount of the rotor blade from a past periodic inspection to the present, or information on the predicted future erosion amount of the rotor blade based on future operating conditions of the actual steam turbine. Furthermore, in the conventional steam turbine management system, the user is not able to learn information on the time when the erosion amount reaches a threshold at which the rotor blade should be replaced in the future, or other information.

### BRIEF DESCRIPTION OF THE DRAWINGS

FIG. 1 is a system diagram schematically illustrating a configuration of a steam turbine facility including an erosion amount managing apparatus in a first embodiment.

FIG. 2 is a block diagram illustrating a functional configuration of the erosion amount managing apparatus in the first embodiment.

FIG. 3 is a view illustrating one example of an input screen for future operating conditions to be displayed on a user interface in the erosion amount managing apparatus in the first embodiment.

FIG. 4 is a view illustrating one example of an input screen for inputting periodic inspection results regarding erosion to the erosion amount managing apparatus in the first embodiment.

FIG. 5 is a flowchart for explaining the flow of arithmetic operation of a past erosion amount in a fixed-cycle erosion arithmetic operation section of the erosion amount managing apparatus in the first embodiment.

FIG. 6 is a flowchart for explaining the flow of arithmetic operation of a future erosion amount in a future erosion arithmetic operation section of the erosion amount managing apparatus in the first embodiment.

FIG. 7 is a view for explaining a method of calculating a recommended replacement time, a recommended preparation time, and a preparation threshold in the future erosion arithmetic operation section of the erosion amount managing apparatus in the first embodiment.

FIG. 8 is a view for explaining the method of calculating the recommended replacement time, the recommended preparation time, and the preparation threshold in the future erosion arithmetic operation section of the erosion amount managing apparatus in the first embodiment.

FIG. 9 is a view illustrating one example of a display screen on which display information was displayed as of the date of installation of the erosion amount managing apparatus in the first embodiment.

FIG. 10 is a flowchart for explaining a method of fixed-cycle erosion arithmetic operation processing in the erosion amount managing apparatus in the first embodiment.

FIG. 11 is a flowchart for explaining a method of future erosion arithmetic operation processing in the erosion amount managing apparatus in the first embodiment.

FIG. 12 is a flowchart for explaining a method of future erosion arithmetic operation processing in the erosion amount managing apparatus in a second embodiment.

FIG. 13 is a flowchart for explaining the method of the future erosion arithmetic operation processing in the erosion amount managing apparatus in the second embodiment.

FIG. 14 is a view illustrating one example of a display screen in the erosion amount managing apparatus in the second embodiment.

FIG. 15 is a view illustrating one example of a selection screen for selecting a comparison arithmetic operation result to be displayed on the user interface in the erosion amount managing apparatus in the second embodiment.

### DETAILED DESCRIPTION

There will be explained embodiments of the present invention below with reference to the drawings.

In one embodiment, a steam turbine rotor blade erosion amount managing apparatus includes a display information generation section configured to generate display information for displaying: past erosion amount related information indicating information on a past erosion amount of a rotor blade of a steam turbine from the past to the present calculated based on measured information; and future erosion amount related information indicating information on a future erosion amount of the rotor blade calculated based on a future operating condition input via a user interface screen and the past erosion amount related information.

### First Embodiment

FIG. 1 is a system diagram schematically illustrating a configuration of a steam turbine facility 1 including an erosion amount managing apparatus 18 in the first embodiment. Incidentally, the erosion amount managing apparatus 18 functions as a steam turbine rotor blade erosion amount managing apparatus.

As illustrated in FIG. 1, the steam turbine facility 1 includes a boiler 10, a high-pressure turbine 11, a reheater 12, an intermediate-pressure turbine 13, a low-pressure turbine 14, a generator 15, a condenser 16, a feed pump 17, and the erosion amount managing apparatus 18. Here, rotor blades of the low-pressure turbine 14 function as the rotor blade of the steam turbine whose erosion amount is managed in the erosion amount managing apparatus 18.

The erosion by water droplets is likely to progress in the downstream turbine stage having a low steam temperature and a low steam pressure in the low-pressure turbine 14. Therefore, the erosion amount managing apparatus 18 manages the erosion amount at the final-stage rotor blade of the low-pressure turbine 14, for example. Incidentally, the erosion amount managing apparatus 18 may manage the erosion amount at a rotor blade of another turbine stage that is subject to erosion by water droplets, in addition to the erosion amount at the final-stage rotor blade.

The steam turbine facility 1 includes the erosion amount managing apparatus 18, a steam temperature detector 30, and an output detector 31 as an erosion amount management system for calculating and managing the erosion amount of a rotor blade in the steam turbine.

The boiler 10 heats feedwater to generate steam, and leads the steam to a main steam pipe 20. The high-pressure turbine 11 is turned by the steam introduced from the main steam pipe 20 and discharges the steam to a low-temperature reheat steam pipe 21. The reheater 12 reheats the steam introduced from the low-temperature reheat steam pipe 21 and leads the steam to a high-temperature reheat steam pipe 22.

The intermediate-pressure turbine 13 is turned by the steam introduced from the high-temperature reheat steam pipe 22 and discharges the steam to a crossover pipe 23. The low-pressure turbine 14 is turned by the steam introduced from the crossover pipe 23 and discharges the steam to an exhaust pipe 24. The generator 15 generates electric power by being driven by the high-pressure turbine 11, the intermediate-pressure turbine 13, and the low-pressure turbine 14. For example, the generator 15 is coaxially connected to the high-pressure turbine 11, the intermediate-pressure turbine 13, and the low-pressure turbine 14.

The condenser 16 condenses the steam introduced from the exhaust pipe 24 into condensed water. The feed pump 17 supplies the condensed water from the condenser 16 to the boiler 10 through a feed pipe 25 as feedwater.

The erosion amount managing apparatus 18 is an apparatus for calculating and managing the erosion amount of a rotor blade in a steam turbine. Incidentally, details of the erosion amount managing apparatus 18 will be described later.

The steam temperature detector 30 detects the temperature of steam to be introduced into the low-pressure turbine 13 to output a detection signal of the detected steam temperature to the erosion amount managing apparatus 18. As illustrated in FIG. 1, the steam temperature detector 30 is provided at, for example, the high-temperature reheat steam pipe 22 and detects the temperature at an inlet of the intermediate-pressure turbine 13. The steam temperature detector 30 is formed of, for example, a thermocouple, and the like. Incidentally, the inlet of the intermediate-pressure turbine 13 refers to the inlet of the turbine stage at the first stage.

The output detector 31 detects the electrical output of the generator 15 to output a detection signal of the detected electrical output to the erosion amount managing apparatus 18.

Next, the erosion amount managing apparatus 18 is explained.

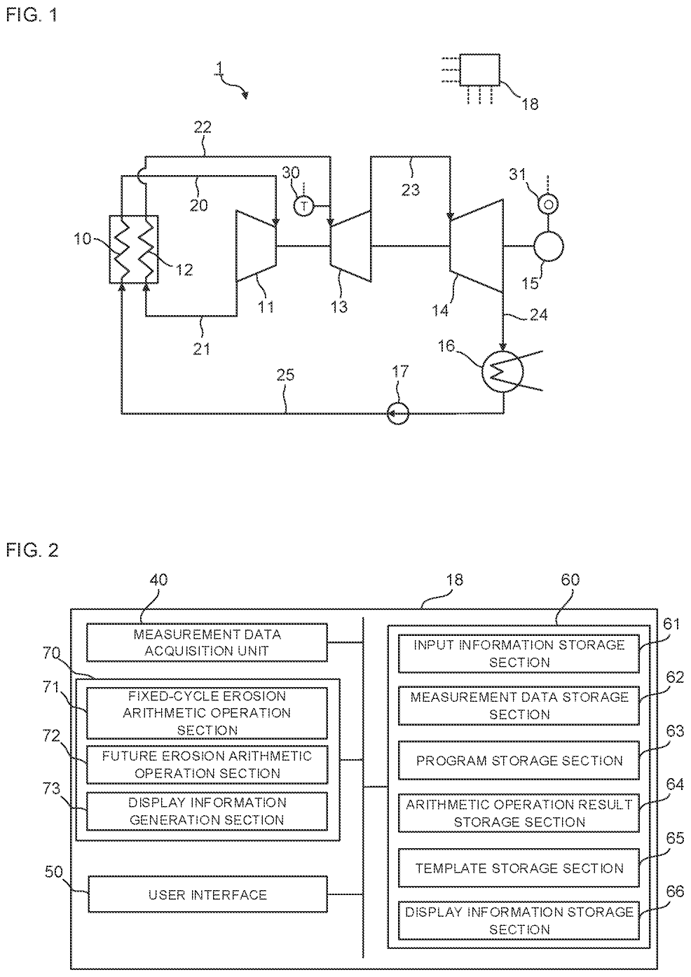

FIG. 2 is a block diagram illustrating a functional configuration of the erosion amount managing apparatus 18 in the first embodiment. The erosion amount managing apparatus 18 is an apparatus that predicts and manages, for example, the erosion amount from the past to the present based on operation data of the actual steam turbine and the future erosion amount based on operating conditions assumed in the future. Further, the erosion amount managing apparatus 18 generates display information for displaying predicted results such as the erosion amount on a display part, for example.

As illustrated in FIG. 2, the erosion amount managing apparatus 18 includes a measurement data acquisition unit 40, a user interface 50, a storage unit 60, and an arithmetic operation unit 70.

The measurement data acquisition unit 40 is an interface that acquires the detection signal related to the steam temperature output from the steam temperature detector 30 and the detection signal related to the electrical output output from the output detector 31. The measurement data acquisition unit 40 acquires these detection signals at predetermined time intervals. The measurement data acquisition unit 40 acquires the detection signals at one-hour intervals, for example.

The measurement data acquisition unit 40 has a function of converting the acquired detection signals into steam temperature information and electrical output information respectively, based on the acquired detection signal related to the steam temperature and the acquired detection signal related to the electrical output. The measurement data acquisition unit 40 outputs the converted steam temperature information and electrical output information to a measurement data storage section 62 of the storage unit 60.

The user interface 50 includes a display part that displays various pieces of information to a user (manager), and an input device through which the user inputs various pieces of information. The display part is configured by a display, and the like, for example. Further, the display part may be configured by a touch panel having a function as a display screen and a function as an input device that allows direct input to the screen. The input device is configured by a keyboard, a mouse, and the like, for example.

The storage unit 60 includes an input information storage section 61, the measurement data storage section 62, a program storage section 63, an arithmetic operation result storage section 64, a template storage section 65, and a display information storage section 66. The storage unit 60 is fabricated by, for example, a hard disk drive, a nonvolatile memory device, or the like. The storage unit 60 may be in a form that is not physically integrated with the erosion amount managing apparatus 18, but is connected thereto via a not-illustrated network.

The input information storage section 61 stores, for example, future operating conditions, various setting conditions, and so on that are input via the user interface 50. Further, the input information storage section 61 stores, for example, various setting conditions, design information of the rotor blade to be managed, information on periodic inspection results related to the erosion amount, and so on, which are input from an input device at a manufacturer that manufactures the erosion amount managing apparatus 18.

Here, the future operating conditions are used in arithmetic operations to predict the future erosion amount. The future operating conditions are future operating conditions in the steam turbine facility 1. The future operating condition includes an operating time per day (24 hours) for each classified load and an annual availability factor. Examples of the future operating condition include a preset default operation mode, a customized operation mode in which a user arbitrarily sets an operating time for each classified load and an annual availability factor, and so on. Here, the “classified load” refers to a load obtained by classifying the load range of a steam turbine (for example, a range from 0% load to 100% load) in units of predetermined load (for example, in units of 10% load). For example, when the load range of the steam turbine from 0% load to 100% load is classified in units of 10% load, the classified loads are 10% load, 20% load, 30% load, 40% load, 50% load, 60% load, 70% load, 80% load, 90% load, and 100% load.

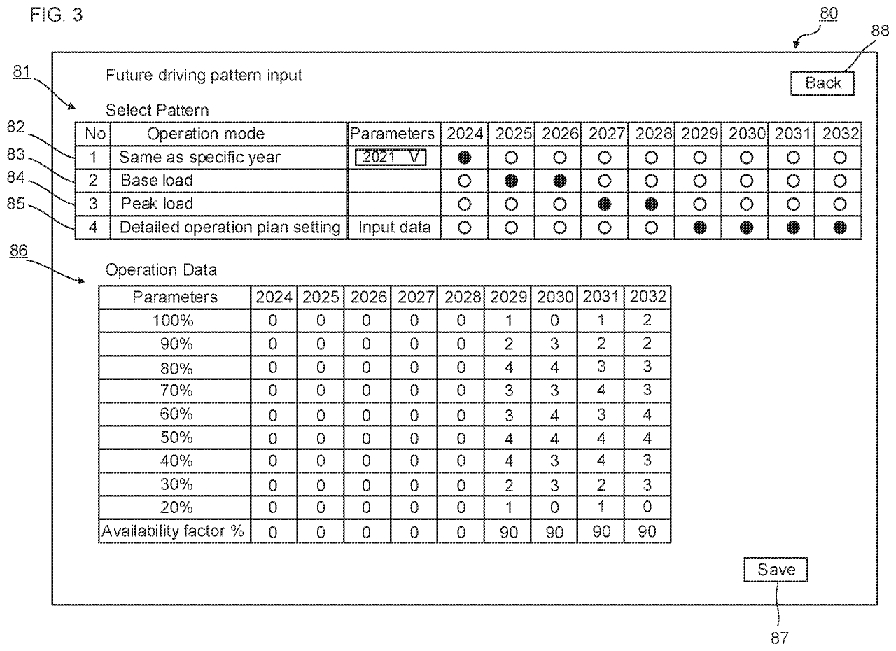

FIG. 3 is a view illustrating one example of an input screen 80 for future operating conditions to be displayed on the user interface 50 in the erosion amount managing apparatus 18 in the first embodiment.

In FIG. 3, as the default operation mode, for example, a past operation performance mode (Same as specific year) 82, a base load operation mode (Base load) 83, and a peak load operation mode (Peak load) 84 have been set. As the customized operation mode, a detailed operation setting mode (Detailed operation plan setting) 85 has been set.

The input screen 80 illustrated in FIG. 3 is one example of a screen selected and input by the user via the user interface 50. In Select Pattern 81 at the top of FIG. 3, the user selects a white circle in the column of Operation mode to be selected for each year and changes it to a black circle. In the input screen 80 illustrated in FIG. 3, the past operation performance mode 82 has been selected for year 2024, the base load operation mode 83 has been selected for year 2025 and year 2026, the peak load operation mode 84 has been selected for year 2027 and year 2028, and the detailed operation setting mode 85 has been selected for year 2029 to year 2032.

Incidentally, although the period up to year 2032 has been illustrated in FIG. 3, the present invention is not limited to this period. For example, a further period such as a period of year 2040 may be set as the period.

The past operation performance mode 82 is a mode in which operation is performed in the same operation pattern as that of the selected year. In the past operation performance mode 82, the operation mode is set based on the classified loads in units of 10% load and the operating time in each classified load, which are calculated from the operation data from January to December of the selected year. Further, in the past operation performance mode 82, the operation mode is set based on the availability factor (Availability factor) of the selected year. Incidentally, in FIG. 3, the operation pattern for year 2021 has been selected.

Here, the availability factor is a ratio of the number of days in which the steam turbine facility 1 is operated in one year for each year. That is, the availability factor is a value obtained by dividing the number of days in which the steam turbine facility 1 is operated in one year by 365 days and expressing the result as a percentage of 100.

The base load operation mode 83 is a mode in which operation is performed at a high load in the range of 70% load to 100% load, for example. In the base load operation mode 83, classified loads, which are obtained by classifying the load range from 70% load to 100% load in units of 10% load, are set, for example. Further, in the base load operation mode 83, the availability factor has been set for each year.

Incidentally, the base load operation mode 83 is a default value, and is set with reference to past operation data in the steam turbine facility 1, for example. The base load operation mode 83 is set, for example, on an annual basis.

Table 1 illustrates one example of the base load operation mode 83.

TABLE 1

| | | Year | | | | | | | | |
|---|---|---|---|---|---|---|---|---|---|---|
| | | 2024 | 2025 | 2026 | 2027 | 2028 | 2029 | 2030 | 2031 | 2032 |
| Load | 100% | 3 hour | 4 hour | 5 hour | 6 hour | 4 hour | 3 hour | 6 hour | 5 hour | 4 hour |
| | 90% | 10 hour | 9 hour | 11 hour | 8 hour | 12 hour | 11 hour | 9 hour | 11 hour | 10 hour |
| | 80% | 9 hour | 8 hour | 7 hour | 8 hour | 5 hour | 8 hour | 8 hour | 5 hour | 8 hour |
| | 70% | 2 hour | 3 hour | 1 hour | 2 hour | 3 hour | 2 hour | 1 hour | 3 hour | 2 hour |

| | | | | | | | | | |
|---|---|---|---|---|---|---|---|---|---|
| Availability factor, % | 89 | 89 | 89 | 89 | 89 | 89 | 89 | 89 | 89 |

Table 1 illustrates one example in which the operating time per day (24 hours) is set for each classified load in each year from year 2024 to year 2032. As illustrated in Table 1, for example, as the base load operation mode 83 for year 2024, 100% load (rated load): 3 hours, 90% load: 10 hours, 80% load: 9 hours, and 70% load: 2 hours have been set. Further, the availability factor has been set to 89%.

Incidentally, although there has been explained one example in which the load range from 100% load to 70% load is classified in units of 10% load as the base load operation mode 83 here, the present invention is not limited to this setting. The load range in the base load operation mode 83 may be set wider or narrower than the range in the above-described example. Further, the load unit may be set wider or narrower than the 10% load unit. Further, the number of years to be set may be smaller or larger than the number of years set in Table 1.

The peak load operation mode 84 is a mode in which operation is performed with load variations in the range from a low load to a rated load (100% load). In the peak load operation mode 84, for example, classified loads, which are obtained by classifying the load range from 100% load to 20% load in units of 10% load, are set. The peak load operation mode 84 is set on an annual basis. Table 2 illustrates one example of the peak load operation mode 84.

TABLE 2

| | | Year | | | | | | | | |
|---|---|---|---|---|---|---|---|---|---|---|
| | | 2024 | 2025 | 2026 | 2027 | 2028 | 2029 | 2030 | 2031 | 2032 |
| Load | 100% | 1 hour | 1 hour | 1 hour | 1 hour | 1 hour | 1 hour | 1 hour | 1 hour | 1 hour |
| | 90% | 5 hour | 5 hour | 5 hour | 5 hour | 5 hour | 6 hour | 7 hour | 7 hour | 4 hour |
| | 80% | 2 hour | 2 hour | 2 hour | 2 hour | 2 hour | 2 hour | 2 hour | 2 hour | 2 hour |
| | 70% | 1 hour | 1 hour | 1 hour | 2 hour | 2 hour | 1 hour | 1 hour | 1 hour | 2 hour |
| | 60% | 1 hour | 1 hour | 1 hour | 1 hour | 1 hour | 1 hour | 1 hour | 1 hour | 1 hour |
| | 50% | 1 hour | 1 hour | 2 hour | 2 hour | 2 hour | 1 hour | 1 hour | 2 hour | 2 hour |
| | 40% | 4 hour | 2 hour | 2 hour | 2 hour | 3 hour | 3 hour | 2 hour | 2 hour | 2 hour |
| | 30% | 8 hour | 3 hour | 3 hour | 3 hour | 3 hour | 8 hour | 3 hour | 2 hour | 3 hour |
| | 20% | 1 hour | 8 hour | 7 hour | 6 hour | 5 hour | 1 hour | 6 hour | 6 hour | 7 hour |

| | | | | | | | | | |
|---|---|---|---|---|---|---|---|---|---|
| Availability factor, % | 89 | 89 | 89 | 89 | 89 | 89 | 89 | 89 | 89 |

In Table 2, the operating time per day (24 hours) has been set for each classified load in each year from year 2024 to year 2032. For example, as the peak load operation mode 84 in year 2024, 100% load (rated load): 1 hour, 90% load: 5 hours, 80% load: 2 hours, 70% load: 1 hour, 60% load: 1 hour, 50% load: 1 hour, 40% load: 4 hours, 30% load: 8 hours, and 20% load: 1 hour have been set. Further, the availability factor has been set to 89%.

Incidentally, the peak load operation mode 84 is a default value, and is set with reference to past operation data in the steam turbine facility 1, for example. Further, although there has been explained one example in which the load range from 100% load to 20% load is classified in units of 10% load as the peak load operation mode 84 here, the present invention is not limited to this setting. The load range in the peak load operation mode 84 may be set wider or narrower than the range in the above-described example. Further, the load unit may be set wider or narrower than the 10% load unit. Further, the number of years to be set may be smaller or larger than the number of years set in Table 2.

In the detailed operation setting mode 85, the operating time per day (24 hours) is arbitrarily set for each classified load illustrated in the column of Operation Data 86 at the bottom in FIG. 3. Further, the availability factor is also set arbitrarily. The user inputs the operating time for each classified load in the column of year in the detailed operation setting mode 85. In FIG. 3, the operating time has been input in the columns of 2029 to 2032 in which the detailed operation setting mode 85 is set.

Further, although there has been explained one example in which the load range from 100% load to 20% load is classified in units of 10% load as Operation Data 86 in the detailed operation setting mode 85 here, the present invention is not limited to this setting. The load range in the detailed operation setting mode 85 may be set wider or narrower than the range in the above-described example. Further, the load unit may be set wider or narrower than the 10% load unit.

Here, the user who has input the above-described future operating condition presses a Save button 87 in FIG. 3. The user interface 50 receives input from the Save button 87 and outputs information related to the future operating condition to the input information storage section 61. The input information storage section 61 receives and stores the information related to the future operating condition.

Further, the input information storage section 61 has stored a correspondence table of the steam temperature information at the inlet of the intermediate-pressure turbine 13 and the electrical output information of the generator 15, which is set based on a heat balance, corresponding to classified loads in the future operating condition. This allows a future erosion arithmetic operation section 72 to arithmetically operate the future erosion amount based on the steam temperature information and the electrical output information, because the steam temperature information and the electrical output information have been stored for each classified load of the future operating condition, for example.

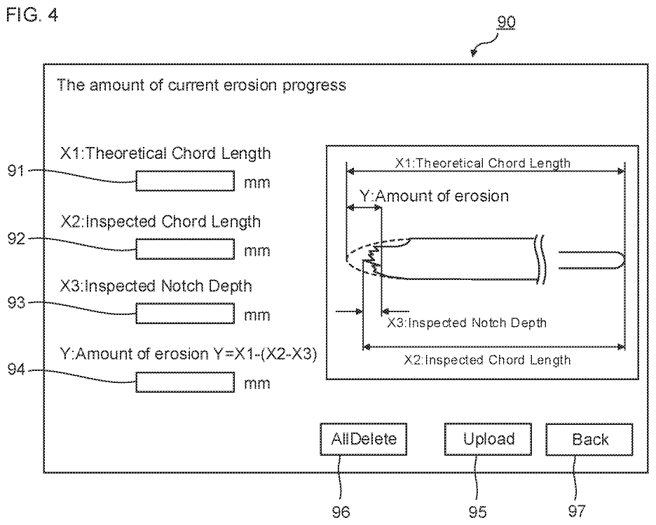

Further, the input information storage section 61 stores information on periodic inspection results related to the erosion amount, and so on. Here, FIG. 4 is a view illustrating one example of an input screen 90 for inputting periodic inspection results regarding erosion to the erosion amount managing apparatus 18 in the first embodiment. Incidentally, the periodic inspection results are input by the manufacturer, for example. The input screen 90 illustrated in FIG. 4 is displayed on, for example, an operation screen of the input device at the manufacturer. Then, the information related to the periodic inspection results from the input device at the manufacturer is output to the input information storage section 61. The input information storage section 61 receives and stores the information related to the periodic inspection results. Incidentally, the input device at the manufacturer has been set to be able to access the erosion amount managing apparatus 18.

“X1: Theoretical Chord Length” illustrated on the input screen 90 in FIG. 4 is the chord length of a new rotor blade. The chord length of a new rotor blade also varies depending on the specifications of the blade, or the like. Therefore, information on the chord length of a new rotor blade has been input by the manufacturer based on the specifications of the blade or the like to be stored in the input information storage section 61. The input chord length is displayed in a numerical value column 91 indicating the value of X1.

“X2: Inspected Chord Length” is the chord length measured during a periodic inspection. “X3: Inspected Notch Depth” is the distance between the most projecting portion and the most depressed portion of V-shaped irregularities of an erosion portion, as illustrated on the input screen 90. “X3: Inspected Notch Depth” is measured during a periodic inspection. “Y: Amount of erosion” is the erosion amount obtained during a periodic inspection. “Y: Amount of erosion” is obtained by arithmetically operating “X1−(X2−X3).”

Numerical values based on the periodic inspection results are input to numerical value columns 92 and 93 of X2 and X3. After inputting the numerical values of X2 and X3, the erosion amount is displayed in a numerical value column 94 of Y.

Then, the input device at the manufacturer receives input from an Upload button 95 and outputs information related to the periodic inspection results to the input information storage section 61. The input information storage section 61 receives and stores the information related to the periodic inspection results. Incidentally, the input device at the manufacturer receives input from an All Delete button 96 and deletes, for example, the numerical values in the numerical value columns 92, 93, and 94 of X2, X3, and Y.

Incidentally, although there has been explained one example in which the manufacturer inputs the periodic inspection results here, the present invention may be set so that the user can input the results. In this case, the input screen 90 illustrated in FIG. 4 is displayed on the display part of the user interface 50. When the user inputs the periodic inspection results, the user presses the Upload button 95 after inputting the periodic inspection results. Then, the user interface 50 receives input from the Upload button 95 and outputs information related to the periodic inspection results to the input information storage section 61. The input information storage section 61 receives and stores the information related to the periodic inspection results. Incidentally, a Back button 97 on the input screen 90 is a button to be pressed when returning to a later-described display screen 100 without pressing the Upload button 95.

Incidentally, the information related to the latest periodic inspection results is an initial erosion value when arithmetically operating the erosion amount in a fixed-cycle erosion arithmetic operation section 71, for example.

The input information storage section 61 stores a replacement threshold, which is an erosion amount at which the rotor blade should be replaced. Here, it is recommended that the rotor blade whose erosion amount has reached the replacement threshold should be replaced. The replacement threshold is, for example, a default value set based on the specifications or the like of the rotor blade. Therefore, the replacement threshold has been stored in the input information storage section 61 in advance. Incidentally, the manufacturer stores the replacement threshold in the input information storage section 61 in advance.

The input information storage section 61 has stored, as an initial value, a preparation period for determining a later-described recommended preparation time, when the erosion amount managing apparatus 18 is installed. The preparation period is a period required to prepare a new rotor blade. Incidentally, the user can change the preparation period from the initial value to a predetermined period by making a request to the manufacturer. In this case, information related to the changed preparation period is output from the input device at the manufacturer to the input information storage section 61 of the erosion amount managing apparatus 18. Then, the input information storage section 61 stores the information related to the changed preparation period.

The measurement data storage section 62 stores the steam temperature information and the electrical output information output from the measurement data acquisition unit 40. The measurement data storage section 62 stores the steam temperature information and the electrical output information to be output from the measurement data acquisition unit 40 every hour, for example.

The program storage section 63 stores programs for executing calculations of the erosion amount and the like and management of the erosion amount in the erosion amount managing apparatus 18, as well as various arithmetic expressions/equations, various parameters, and the like for calculating the erosion amount and the like.

The arithmetic operation result storage section 64 stores results arithmetically operated in the arithmetic operation unit 70. The arithmetic operation result storage section 64 stores information on the erosion amount from the past to the present, which is arithmetically operated in the fixed-cycle erosion arithmetic operation section 71, for example. Here, the arithmetic operation result storage section 64 stores, for example, arithmetic operation results of the erosion amount from the past to the present, and the like, as the information on the erosion amount from the past to the present. Incidentally, this information functions as past erosion amount related information.

The arithmetic operation result storage section 64 stores information on the future erosion amount arithmetically operated in the future erosion arithmetic operation section 72, for example. The arithmetic operation result storage section 64 stores a recommended replacement time at which the future erosion amount calculated by the arithmetic operation in the future erosion arithmetic operation section 72 reaches the replacement threshold. Incidentally, the recommended replacement time is specified by year, month, and day. The method of calculating the recommended replacement time will be explained later.

Here, the time from the recommended replacement time before a predetermined preparation period is set as the recommended preparation time. The recommended preparation time refers to the time at which it is recommended to start preparation for a new rotor blade for the rotor blade whose recommended replacement time has been specified. Incidentally, the recommended preparation time is also specified by year, month, and day, similarly to the recommended replacement time. For example, when the recommended replacement time is Jun. 1, 2040 and the preparation period is 3 years, the recommended preparation time is Jun. 1, 2037. The preparation period has been stored in the input information storage section 61, as described previously.

Further, the arithmetic operation result storage section 64 stores as a preparation threshold the future erosion amount at the recommended preparation time, which is arithmetically operated by the future erosion arithmetic operation section 72. That is, the erosion amount at the recommended preparation time is the preparation threshold. The method of calculating the preparation threshold will be explained later.

The arithmetic operation result storage section 64 stores arithmetic operation results of, for example, the future erosion amount, the preparation threshold, the recommended preparation time, the recommended replacement time, and so on as information on the future erosion amount. Incidentally, these pieces of information function as future erosion amount related information.

The template storage section 65 stores information related to template screens that serve as bases for the screens that display the arithmetic operation results stored in the arithmetic operation result storage section 64. Pieces of information related to various template screens to be displayed on the display part of the user interface 50 have been stored in the template storage section 65 in advance.

The display information storage section 66 stores display information to be displayed on the display part, which is generated in a display information generation section 73 of the arithmetic operation unit 70.

The arithmetic operation unit 70 is an arithmetic operation block including the fixed-cycle erosion arithmetic operation section 71, the future erosion arithmetic operation section 72, and the display information generation section 73. The arithmetic operation unit 70 reads a program for executing the erosion amount managing apparatus 18 from the program storage section 63 in response to an execution start input by the user from the user interface 50. This makes it possible to execute the functions of the fixed-cycle erosion arithmetic operation section 71, the future erosion arithmetic operation section 72, and the display information generation section 73.

The fixed-cycle erosion arithmetic operation section 71 is an arithmetic operation block that reads arithmetic expressions/equations and parameters for calculating the erosion amount from the program storage section 63 and calculates the erosion amount in a fixed-cycle based on the steam temperature information and the electrical output information stored in the measurement data storage section 62. The fixed-cycle erosion arithmetic operation section 71 outputs information related to the calculated erosion amount to the arithmetic operation result storage section 64.

Here, the fixed-cycle refers to, for example, a one-hour cycle from a predetermined date in the past to the present. The fixed-cycle erosion arithmetic operation section 71 calculates the erosion amount every fixed-cycle (for example, every hour) based on the steam temperature information and the electrical output information, while using the erosion amount measured during a periodic inspection on a predetermined date in the past as an initial value. Then, the erosion amount at the present is calculated by adding the erosion amount that has progressed from a predetermined date in the past to the present to the erosion amount measured during the periodic inspection on the predetermined date in the past. Incidentally, the erosion amount that has progressed from the predetermined date in the past to the present, which is calculated by the fixed-cycle erosion arithmetic operation section 71, is a predicted value.

Further, the fixed-cycle erosion arithmetic operation section 71 determines whether or not the calculated erosion amount has reached the replacement threshold based on the replacement threshold stored in the input information storage section 61. Further, the fixed-cycle erosion arithmetic operation section 71 determines whether or not the calculated erosion amount has reached the preparation threshold based on the preparation threshold stored in the input information storage section 61. Incidentally, the operation related to this determination in the fixed-cycle erosion arithmetic operation section 71 will be described later.

The future erosion arithmetic operation section 72 is an arithmetic operation block that reads arithmetic expressions/equations and parameters for calculating the erosion amount from the program storage section 63 and calculates the future erosion amount based on the future operating conditions stored in the input information storage section 61. The future erosion arithmetic operation section 72 outputs information related to the calculated erosion amount to the arithmetic operation result storage section 64.

Here, the future refers to the period from the present to a year in the future set as the future operating condition. The future erosion arithmetic operation section 72 calculates the future erosion amount every predetermined year (for example, every year) based on the future operating condition stored in the input information storage section 61, while using the present erosion amount calculated in the fixed-cycle erosion arithmetic operation section 71 as an initial value. Incidentally, the future erosion amount calculated by the future erosion arithmetic operation section 72 is a predicted value.

Further, the future erosion arithmetic operation section 72 determines whether or not the future erosion amount has reached the replacement threshold based on the replacement threshold stored in the input information storage section 61 and the calculated future erosion amount. When determining that the future erosion amount has reached the replacement threshold, the future erosion arithmetic operation section 72 calculates the recommended replacement time at which the future erosion amount reaches the replacement threshold.

Furthermore, when determining that the future erosion amount has reached the replacement threshold, the future erosion arithmetic operation section 72 calculates the recommended preparation time and the preparation threshold based on the preparation period described previously.

Here, for convenience of explanation, the erosion amount from the past to the present arithmetically operated by the fixed-cycle erosion arithmetic operation section 71 is referred to as a past erosion amount, and the erosion amount from the present to a predetermined date in the future arithmetically operated by the future erosion arithmetic operation section 72 is referred to as a future erosion amount.

The display information generation section 73 is an arithmetic operation block that generates display information to be displayed on the display part of the user interface 50. The display information generation section 73 generates display information based on the information stored in the arithmetic operation result storage section 64 and the template storage section 65. Incidentally, the display information generation section 73 may directly receive the arithmetic operation results of the fixed-cycle erosion arithmetic operation section 71 and the future erosion arithmetic operation section 72 and generate the display information based on the information stored in the template storage section 65, for example.

The display information generation section 73 outputs the generated display information to the display information storage section 66. Further, the display information storage section 73 outputs the generated display information to the user interface 50.

Here, the erosion amount managing apparatus 18 described above can be configured by a computer device or the like, which includes an arithmetic device such as a CPU (Central Processing Unit), a storage device such as a ROM (Read Only Memory) or RAM (Random Access Memory), an external storage device such as a HDD (Hard Disk Drive) or CD (Compact Disc) drive device, a display device such as a display, an input device such as a keyboard or a mouse, and so on.

### (Arithmetic Operations in the Fixed-Cycle Erosion Arithmetic Operation Section 71 and the Future Erosion Arithmetic Operation Section 72)

Here, the flows of arithmetic operations in the fixed-cycle erosion arithmetic operation section 71 and the future erosion arithmetic operation section 72 are explained.

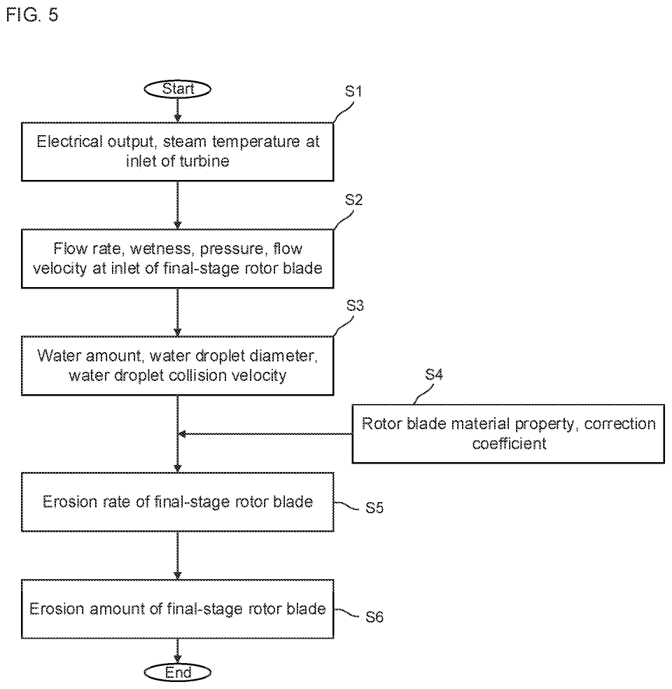

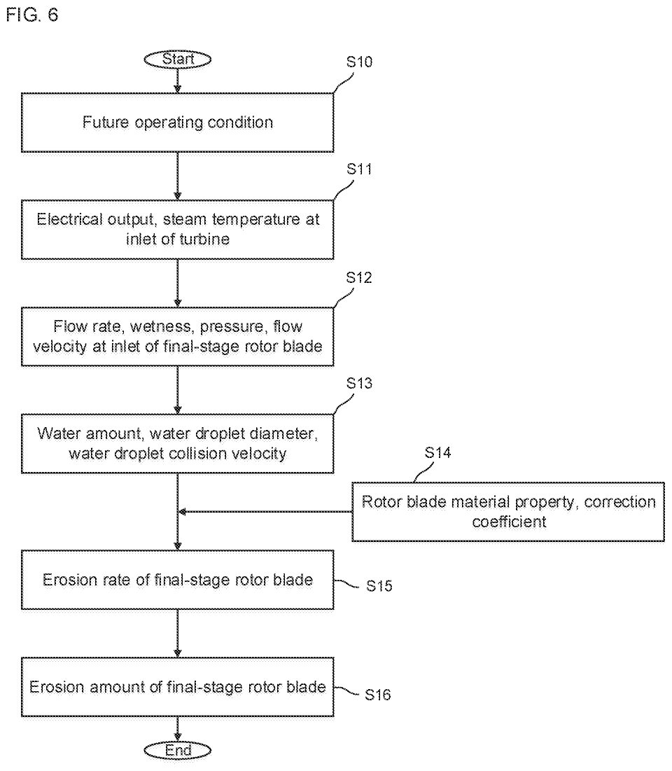

FIG. 5 is a flowchart for explaining the flow of arithmetic operation of the past erosion amount in the fixed-cycle erosion arithmetic operation section 71 of the erosion amount managing apparatus 18 in the first embodiment. FIG. 6 is a flowchart for explaining the flow of arithmetic operation of the future erosion amount in the future erosion arithmetic operation section 72 of the erosion amount managing apparatus 18 in the first embodiment.

First, referring to FIG. 5, the flow of the arithmetic operation of the past erosion amount in the fixed-cycle erosion arithmetic operation section 71 is explained.

As illustrated in FIG. 5, the fixed-cycle erosion arithmetic operation section 71 reads the steam temperature at the inlet of the turbine and the electrical output of the generator 15 from the measurement data storage section 62 (Step S1). Here, the steam temperature at the inlet of the turbine and the electrical output of the generator 15 function as measured information for arithmetically operating the past erosion amount. Here, for example, the temperature of steam to be introduced into the intermediate-pressure turbine 13 is used as the steam temperature at the inlet of the turbine. Incidentally, when executing Step S1, the fixed-cycle erosion arithmetic operation section 71 has already read the program for executing the arithmetic operation of the past erosion amount and the arithmetic expressions/equations and parameters for calculating the past erosion amount from the program storage section 63, the design information of the rotor blade to be managed from the input information storage section 61, and so on.

Then, the fixed-cycle erosion arithmetic operation section 71 arithmetically operates the flow rate, wetness, pressure, and flow velocity of the steam at the inlet of the final-stage rotor blade of the low-pressure turbine 14 based on the steam temperature information and the electrical output information (Step S2). Incidentally, a program for a fluid analysis or one-dimensional steam calculation may be stored in the fixed-cycle erosion arithmetic operation section 71 in advance, and the fixed-cycle erosion arithmetic operation section 71 may calculate the flow rate, wetness, pressure, and flow velocity at the inlet of the final-stage rotor blade by reading the steam temperature information and the electrical output information.

Then, the fixed-cycle erosion arithmetic operation section 71 arithmetically operates the water amount (number of water droplets) in the steam at the inlet of the final-stage rotor blade, the water droplet diameter, and the water droplet collision velocity based on the flow rate, wetness, pressure, and flow velocity at the inlet of the final-stage rotor blade (Step S3).

The fixed-cycle erosion arithmetic operation section 71 calculates the water amount based on the flow rate and the wetness. The fixed-cycle erosion arithmetic operation section 71 calculates a water droplet diameter D by Equation (1) below using a pressure ρ, a flow velocity W, and a Weber number Weσ.

$$D = We σ / ( ρ {W}^{2} ) \qquad Equation ( 1 )$$

The Weber number Weσ is a non-dimensional number representing the ratio of the inertial force of steam to the surface tension of a water droplet. The water droplet diameter D becomes smaller as the pressure ρ increases.

The fixed-cycle erosion arithmetic operation section 71 calculates the water droplet collision velocity by calculating the trajectory of the water droplet from the flow velocity W and the water droplet diameter D. The larger the water droplet diameter is, the more difficult it is for the water droplet to be accelerated by the steam and the greater the difference in velocity between the steam and the water droplet. Therefore, the velocity at which a water droplet collides with the rotor blade increases. Incidentally, the fixed-cycle erosion arithmetic operation section 71 may store a water droplet trajectory analysis program in advance and calculate the water droplet collision velocity.

Then, the fixed-cycle erosion arithmetic operation section 71 arithmetically operates the erosion rate of the final-stage rotor blade (Step S5). Here, an erosion amount E in a stable period when the erosion rate becomes a certain constant value is expressed by Equation (2) below as a property that varies linearly with a time t.

$$E = a + bt \qquad Equation ( 2 )$$

Here, a is a material property. By time-differentiating Equation (2), the erosion rate dE/dt, which is the erosion amount E per unit time, is expressed by Equation (3) below.

$$dE / dt = b \qquad Equation ( 3 )$$

Here, b is usually a function of the water droplet collision velocity V, the water droplet diameter D, the water amount (the number of water droplets N), and the material property, and is expressed by Equation (4) below.

$$b = C 1 \times {V}^{p 1} \times {D}^{q 1} \times N \qquad Equation ( 4 )$$

Here, C1, p1, and q1 are material constants.

The material property of the final-stage rotor blade and a correction coefficient have been stored in the input information storage section 61 in advance. When arithmetically operating the erosion rate using Equation (3), the fixed-cycle erosion arithmetic operation section 71 reads the material property and the correction coefficient from the input information storage section 61 and uses them for arithmetically operating the erosion rate (Step S4). Incidentally, the correction coefficient is the slope or intercept of the entire Equation (2), and is used to finely adjust the graph shape determined by Equation (2).

Then, the fixed-cycle erosion arithmetic operation section 71 arithmetically operates an erosion amount ΔE in a certain time range Δt by Equation (5) below (Step S6).

$$Δ E = dE / dt \times Δ t \qquad Equation ( 5 )$$

Thus, the erosion amount E is calculated based on the erosion rate dE/dt. Specifically, the fixed-cycle erosion arithmetic operation section 71 integrates the erosion amount ΔE arithmetically operated using Equation (5) over an operating time (from a predetermined date in the past to the present) of the steam turbine facility, to thereby calculate the erosion amount E.

Here, the fixed-cycle erosion arithmetic operation section 71 calculates the past erosion amount by adding the erosion amount measured during a periodic inspection on a predetermined date in the past to the erosion amount E calculated by the above-described arithmetic operation. As a result, the past erosion amount of the final stage that has reflected the operation of the low-pressure turbine 14 can be obtained.

Incidentally, the fixed-cycle erosion arithmetic operation section 71 outputs the arithmetic operation result to the arithmetic operation result storage section 64. The arithmetic operation of the past erosion amount in the fixed-cycle erosion arithmetic operation section 71 described above is executed every hour, for example. The most recently calculated past erosion amount corresponds to the present erosion amount.

Next, referring to FIG. 6, the flow of the arithmetic operation of the future erosion amount in the future erosion arithmetic operation section 72 is explained.

The arithmetic operation flow of the future erosion arithmetic operation section 72 is basically the same as that of the fixed-cycle erosion arithmetic operation section 71 except for Step S10 and Step S11 illustrated in FIG. 6. That is, pieces of the processing at Step S12 to Step S16 in the arithmetic operation by the future erosion arithmetic operation section 72 are basically the same as those at Step S2 to Step S6 in the arithmetic operation by the fixed-cycle erosion arithmetic operation section 71. Therefore, pieces of the processing at Step S10 and Step S11 in the arithmetic operation by the future erosion arithmetic operation section 72 are mainly explained.

As illustrated in FIG. 6, the future erosion arithmetic operation section 72 reads the future operating condition from the input information storage section 61 (Step S10). Incidentally, when executing Step S10, the future erosion arithmetic operation section 72 has already read the program for executing the arithmetic operation of the future erosion amount and the arithmetic expressions/equations and parameters for calculating the future erosion amount from the program storage section 63, the design information of the rotor blade to be managed from the input information storage section 61, and so on.

Then, the future erosion arithmetic operation section 72 reads the steam temperature information at the inlet of the intermediate-pressure turbine 13 and the electrical output information of the generator 15, which are preset correspondingly to the classified loads, from the input information storage section 61 based on the future operating condition (Step S11). Incidentally, in this arithmetic operation, the steam temperature information and the electrical output information read from the input information storage section 61 are handled in the same way as the steam temperature information at the inlet of the turbine and the electrical output information of the generator 15 read from the measurement data storage section 62 in the previously-described arithmetic operation by the fixed-cycle erosion arithmetic operation section 71.

Then, the future erosion arithmetic operation section 72 arithmetically operates the flow rate, wetness, pressure, and flow velocity of the steam at the inlet of the final-stage rotor blade of the low-pressure turbine 14 based on the steam temperature information and the electrical output information, similarly to the arithmetic operation by the fixed-cycle erosion arithmetic operation section 71 (Step S12).

The future erosion arithmetic operation section 72 calculates the erosion amount E by executing pieces of the processing at Step S12 to Step S15. Here, at Step S16, the future erosion arithmetic operation section 72 integrates the erosion amount ΔE arithmetically operated using Equation (5) over an operating time (from the present to a predetermined date in the future) of the steam turbine facility, to thereby calculate the erosion amount E.

The future erosion arithmetic operation section 72 calculates the future erosion amount on a predetermined date in the future by adding the most recent past erosion amount calculated by the fixed-cycle erosion arithmetic operation section 71 to the calculated erosion amount E that will progress from the present to a predetermined date in the future. As a result, the future erosion amount of the final stage that has reflected the future operation in the low-pressure turbine 14 can be obtained.

Incidentally, the future erosion arithmetic operation section 72 outputs the arithmetic operation result to the arithmetic operation result storage section 64. The arithmetic operation result of the future erosion amount in the future erosion arithmetic operation section 72 described above is obtained for each one-year cycle set as the future operating condition. That is, the arithmetic operation result in the future erosion arithmetic operation section 72 is obtained in units of one year.

### (Calculations of the Recommended Replacement Time, the Recommended Preparation Time, and the Preparation Threshold)

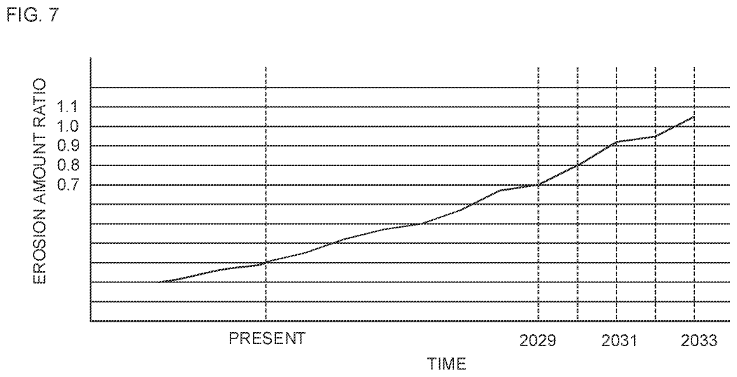

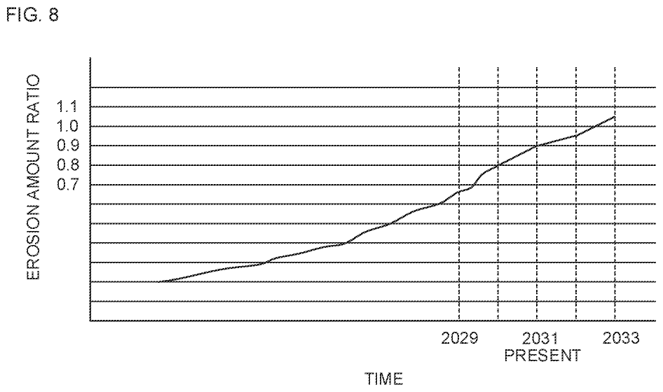

Here, the method of calculating the recommended replacement time, the recommended preparation time, and the preparation threshold is explained. FIG. 7 and FIG. 8 are views for explaining the method of calculating the recommended replacement time, the recommended preparation time, and the preparation threshold in the future erosion arithmetic operation section 72 of the erosion amount managing apparatus 18 in the first embodiment. In FIG. 7 and FIG. 8, the horizontal axis indicates a time (year), and the vertical axis indicates an erosion amount ratio. Incidentally, the assumed month and day in each year on the horizontal axis is January 1 here.

Here, the erosion amount is described as the erosion amount ratio. The erosion amount ratio is the erosion amount ratio when the erosion amount at the replacement threshold is set to 1. When the erosion amount ratio is smaller than 1.0, the erosion amount is below the replacement threshold. When the erosion amount ratio is larger than 1.0, the erosion amount exceeds the replacement threshold.

First, referring to FIG. 7, there is explained the case where the time when the erosion amount reaches the preparation threshold is the future.

As illustrated in FIG. 7, the erosion amount ratio in year 2032 is smaller than 1, and the erosion amount ratio in year 2033 is larger than 1.0. Therefore, the erosion amount ratio reaches 1.0 during the period between year 2032 and year 2033. That is, the recommended replacement time exists during the period between year 2032 and year 2033.

The future erosion arithmetic operation section 72 expresses the relationship between a time and an erosion amount ratio as a linear function during the period between year 2032 and year 2033. Then, the future erosion arithmetic operation section 72 calculates the month and day when the erosion amount ratio becomes 1.0.

In the example illustrated in FIG. 7, the erosion amount ratio in year 2032 is 0.95, and the erosion amount ratio in year 2033 is 1.05. The future erosion arithmetic operation section 72 calculates the recommended replacement time when the erosion amount ratio becomes 1.0 based on the linear function. In the example illustrated in FIG. 7, as a result of the arithmetic operation, Jul. 1, 2032 is the recommended replacement time.

Then, the future erosion arithmetic operation section 72 calculates the recommended preparation time based on the recommended replacement time and the preparation period. Here, when the preparation period is set to 3 years, the recommended preparation time is Jul. 1, 2029, which is 3 years before the recommended replacement time.

Then, the future erosion arithmetic operation section 72 expresses the relationship between a time and an erosion amount ratio as a linear function during the period between year 2029 and year 2030. Then, the future erosion arithmetic operation section 72 calculates the erosion amount ratio on Jul. 1, 2029. In the example illustrated in FIG. 7, as a result of the arithmetic operation, the erosion amount ratio on Jul. 1, 2029 is 0.75. This result reveals that the preparation threshold, which is the erosion amount ratio at the recommended preparation time, is 0.75.

Then, the future erosion arithmetic operation section 72 outputs the above-described arithmetic operation results of the recommended replacement time, the recommended preparation time, and the preparation threshold to the arithmetic operation result storage section 64. The arithmetic operation result storage section 64 receives and stores the arithmetic operation results of the recommended replacement time, the recommended preparation time, and the preparation threshold.

Next, referring to FIG. 8, there is explained the case where the time when the erosion amount reaches the preparation threshold is the past.

As illustrated in FIG. 8, the erosion amount ratio reaches 1.0 during the period between year 2032 and year 2033. That is, the recommended replacement time exists during the period between year 2032 and year 2033. Therefore, the recommended preparation time exists in the past rather than at present (year 2031).

As illustrated in FIG. 8, as in the explanation with reference to FIG. 7, the future erosion arithmetic operation section 72 calculates the month and day when the erosion amount ratio is 1.0 by expressing the relationship between a time and an erosion amount ratio as a linear function during the period between year 2032 and year 2033.

In the example illustrated in FIG. 8, the erosion amount ratio in year 2032 is 0.95, and the erosion amount ratio in year 2033 is 1.05. In the example illustrated in FIG. 8, as a result of the arithmetic operation, Jul. 1, 2032 is the recommended replacement time.

Then, the future erosion arithmetic operation section 72 calculates the recommended preparation time based on the recommended replacement time and the preparation period. Here, when the preparation period is set to 3 years, the recommended preparation time is Jul. 1, 2029, which is 3 years before the recommended replacement time.

Then, the future erosion arithmetic operation section 72 reads the erosion amount on Jul. 1, 2029 from the arithmetic operation result storage section 64 and calculates the erosion amount ratio. This calculated erosion amount ratio is the preparation threshold.

Here, the erosion amount on Jul. 1, 2029 is the result of the arithmetic operation by the fixed-cycle erosion arithmetic operation section 71. Therefore, the arithmetic operation result storage section 64 has stored a plurality of data every hour as the arithmetic operation result for this day. Thus, as the erosion amount on Jul. 1, 2029, the future erosion arithmetic operation section 72 refers to the largest erosion amount in pieces of the data of the erosion amount on Jul. 1, 2029, for example.

Then, the future erosion arithmetic operation section 72 outputs the above-described arithmetic operation results of the recommended replacement time, the recommended preparation time, and the preparation threshold to the arithmetic operation result storage section 64. The arithmetic operation result storage section 64 receives and stores the arithmetic operation results of the recommended replacement time, the recommended preparation time, and the preparation threshold.

Here, as a result of the arithmetic operation of the future erosion amount, when the erosion amount ratio does not reach 1.0 during a specified future arithmetic operation period, the recommended replacement time, the recommended preparation time, and the preparation threshold are not obtained.

### (Regarding the Erosion Amount Managing Apparatus 18 at the Time of Installation)

Here, the state of the erosion amount managing apparatus 18 at the time of installation is first explained.

At the time of installation of the erosion amount managing apparatus 18, the display information storage section 66 has stored display information on the past erosion amount and the future erosion amount as of the date of installation. That is, at the time of installation, the erosion amount managing apparatus 18 is in a state of being capable of displaying the past erosion amount and the future erosion amount as of the date of installation on the display part of the user interface 50.

That is, the display information storage section 66 has stored the display information as of the date of installation generated by the display information generation section 73 based on the arithmetic operation results obtained by arithmetic operations by the fixed-cycle erosion arithmetic operation section 71 and the future erosion arithmetic operation section 72 stored in the arithmetic operation result storage section 64 and the information related to the template screens stored in the template storage section 65.

Incidentally, the manufacturer has processed the erosion amount managing apparatus 18 so as to bring it into the above-described state as of the date of installation.

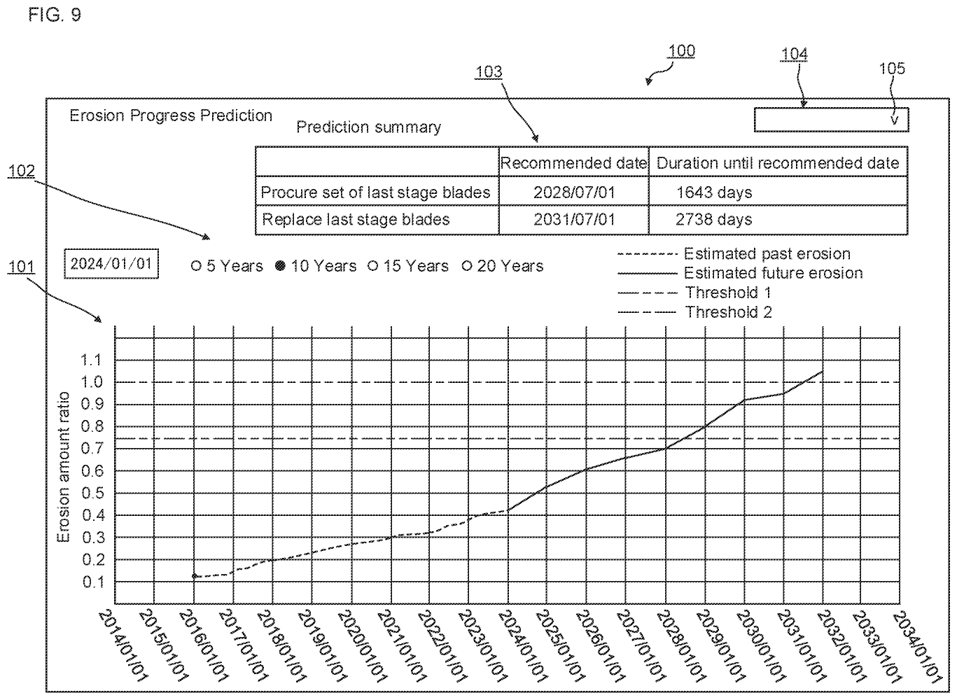

Here, FIG. 9 is a view illustrating one example of the display screen 100 on which the display information was displayed as of the date of installation of the erosion amount managing apparatus 18 in the first embodiment.

As illustrated in FIG. 9, on the display screen 100, the result of the past erosion amount arithmetically operated by the fixed-cycle erosion arithmetic operation section 71 (dotted line) and the result of the future erosion amount arithmetically operated by the future erosion arithmetic operation section 72 (solid line) have been illustrated in chronological order. In a graph 101 illustrating the results of these erosion amounts, the horizontal axis indicates year, month, and day, and the vertical axis indicates an erosion amount ratio. Incidentally, Jan. 1, 2024 is set as the present here. Incidentally, in the graph 101, the erosion amount is illustrated as the erosion amount ratio. The erosion amount ratio is as described above.

FIG. 9 illustrates a time axis from Jan. 1, 2014 to Jan. 1, 2034. The range of this time axis is set by selecting a set value of a time axis setting portion 102 on the display screen 100. There is illustrated one example here in which 5 years, 10 years, 15 years, and 20 years are set as the set value of the time axis setting portion 102. Incidentally, in FIG. 9, the set value of 10 years has been selected.

The time axis indicates the past for the set value from the present and the future for the set value from the present. For example, when the set value of 10 years is selected as illustrated in FIG. 9, the time range for the past 10 years from the present (Jan. 1, 2024) to Jan. 1, 2014 and the time range for the future 10 years from the present (Jan. 1, 2024) to Jan. 1, 2034 are displayed as the time axis.

Thus, the user can arbitrarily change the range of the time axis by selecting the set value in the time axis setting portion 102.

Incidentally, in FIG. 9, the arithmetic operation results from Jan. 1, 2016 to Jan. 1, 2032 have been illustrated as the erosion amount. In this case, the erosion amount ratios from Jan. 1, 2016 to Jan. 1, 2024 are the erosion amount ratio based on the past erosion amount, and the erosion amount ratios from Jan. 1, 2024 to Jan. 1, 2032 are the erosion amount ratio based on the future erosion amount.

Here, the erosion amount ratio on Jan. 1, 2016 has been illustrated based on the periodic inspection results input from the input screen 90 illustrated in FIG. 4. In the graph 101 on the display screen 100, the erosion amount ratio based on the periodic inspection results has been illustrated by a black circle. Incidentally, even in the case where there are arithmetic operation results prior to the latest periodic inspection, for example, the arithmetic operation results of and after the latest periodic inspection are displayed on the display screen 100, and the arithmetic operation results prior to the latest periodic inspection are not displayed.

Further, on the display screen 100, the replacement threshold has been illustrated as “Threshold 2” by a dot and dash line, and the preparation threshold has been illustrated as “Threshold 1” by a two-dot chain line. Incidentally, in the graph 101, the erosion amount of the replacement threshold has been illustrated as an erosion amount ratio 1. Further, the preparation threshold illustrated in the graph 101 has been illustrated as an erosion amount ratio when the erosion amount of the replacement threshold is set to 1.

An alarm display 103 is displayed on the display screen 100. The alarm display 103 is displayed when the future erosion amount or past erosion amount exceeds the replacement threshold.

Incidentally, the replacement threshold is a default value stored in the input information storage section 61 as an initial value, and thus, “Threshold 2” has always been displayed on the display screen 100. Further, when the future erosion amount has not reached the replacement threshold, the preparation threshold, the recommended replacement time, and the recommended preparation time are not calculated. Therefore, the alarm display 103 is not displayed on the display screen 100.

As the alarm display 103, the recommended replacement time and the recommended preparation time have been illustrated. Further, in FIG. 9, there has been illustrated one example of the alarm display 103 displaying the number of days from the present until the recommended replacement time and the number of days from the present until the recommended preparation time. Incidentally, the alarm display 103 includes at least the recommended replacement time and the recommended preparation time. Incidentally, the replacement threshold, the preparation threshold, the recommended replacement time, and the recommended preparation time are as described previously.

As illustrated in FIG. 9, on the display screen 100 of the user interface 50, variations in the past erosion amount and the future erosion amount over time are displayed on the single graph 101. Further, when the future erosion amount exceeds the replacement threshold, the preparation threshold, the recommended replacement time, and the recommended preparation time are displayed on the display screen 100.

### (Fixed-Cycle Erosion Arithmetic Operation Processing)

Next, there is explained fixed-cycle erosion arithmetic operation processing in the erosion amount managing apparatus 18 in the first embodiment.

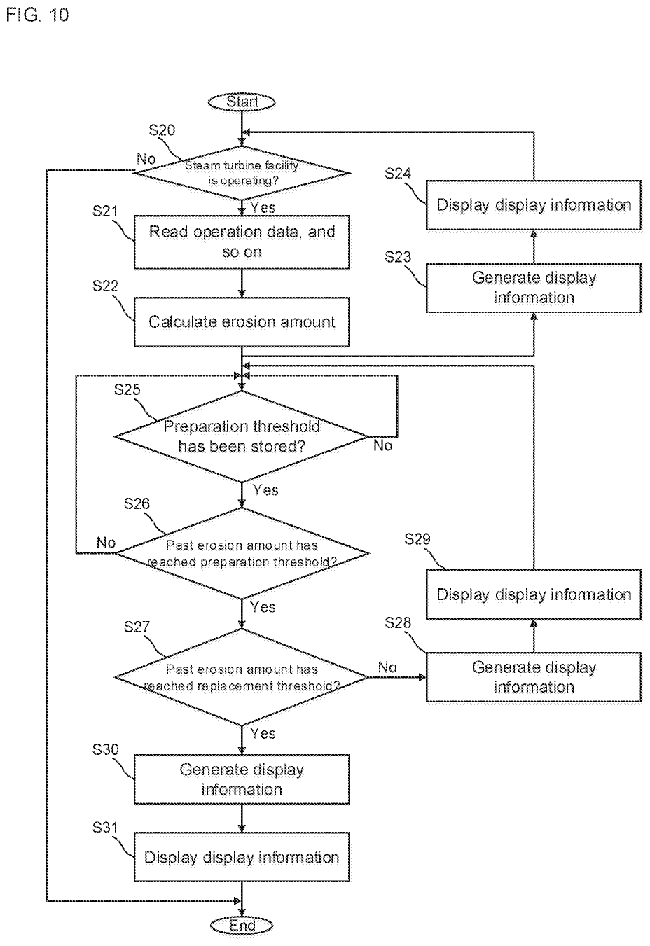

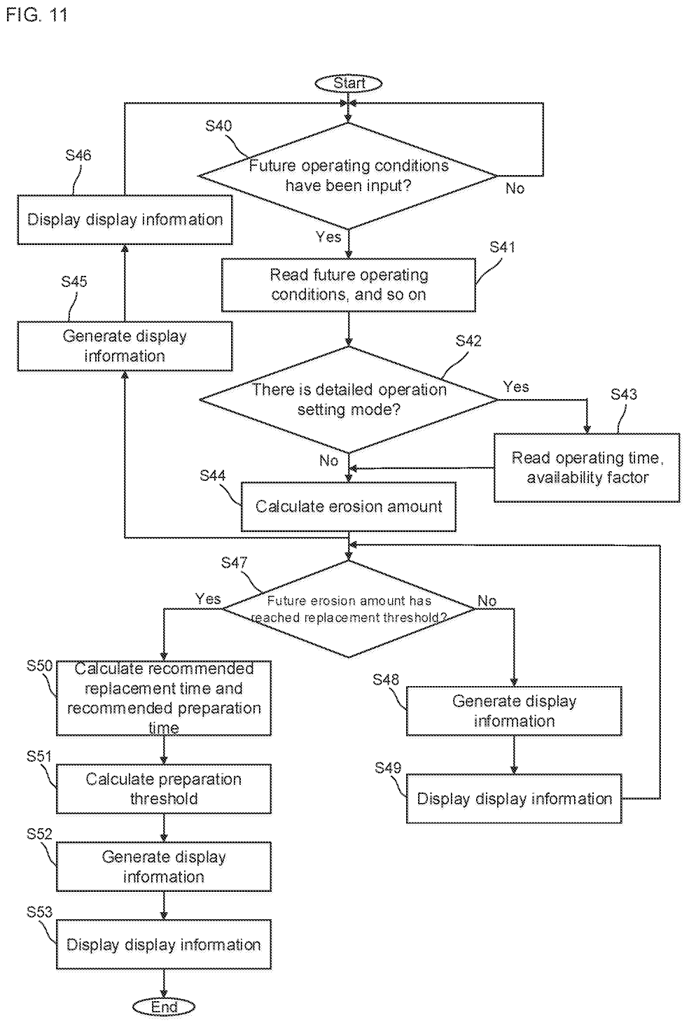

FIG. 10 is a flowchart for explaining a method of the fixed-cycle erosion arithmetic operation processing in the erosion amount managing apparatus 18 in the first embodiment.

As illustrated in FIG. 10, the fixed-cycle erosion arithmetic operation section 71 determines whether or not the steam turbine facility 1 is operating based on the information stored in the measurement data storage section 62, for example (Step S20). The fixed-cycle erosion arithmetic operation section 71 determines whether or not the steam turbine facility 1 is operating based on, for example, the steam temperature information and the electrical output information.

When determining in the determination of Step S20 that the steam turbine facility 1 is not operating (No at Step S20), the fixed-cycle erosion arithmetic operation section 71 finishes the fixed-cycle erosion arithmetic operation processing.

When determining in the determination of Step S20 that the steam turbine facility 1 is operating (Yes at Step S20), the fixed-cycle erosion arithmetic operation section 71 reads the program for executing the arithmetic operation of the past erosion amount and the arithmetic expressions/equations and parameters for calculating the past erosion amount from the program storage section 63, the design information of the rotor blade to be managed from the input information storage section 61, and the steam temperature at the inlet of the turbine and the electrical output of the generator 15 stored in the measurement data storage section 62 (Step S21).

Then, the fixed-cycle erosion arithmetic operation section 71 arithmetically operates the past erosion amount using the arithmetic operation method explained with reference to FIG. 5, and outputs the arithmetic operation result to the arithmetic operation result storage section 64 (Step S22). The arithmetic operation result storage section 64 stores the arithmetic operation result.

The display information generation section 73 generates display information based on the arithmetic operation result stored in the arithmetic operation result storage section 64 and the information stored in the template storage section 65 (Step S23). Then, the display information generation section 73 outputs the generated display information to the display information storage section 66 and the user interface 50. The display information storage section 66 stores the display information.

The user interface 50 displays the display information output from the display information generation section 73 on the display part as illustrated in FIG. 9 (Step S24).

Here, the display information generation section 73 outputs the display information based on the arithmetic operation result to the display information storage section 66 and the user interface 50 every hour. Therefore, the graph 101 illustrating the arithmetic operation result regarding the past erosion amount displayed on the display part is updated every hour. For example, after arithmetically operating the past erosion amount, the fixed-cycle erosion arithmetic operation section 71 performs pieces of the processing at Step S20 to Step S24 repeatedly every hour.

Further, after the processing at Step S22, the fixed-cycle erosion arithmetic operation section 71 refers to the arithmetic operation result storage section 64 to determine whether or not the preparation threshold has been stored (Step S25).

Here, for example, in the case where the future erosion amount has reached the replacement threshold within the specified future arithmetic operation period in the arithmetic operation of the future erosion amount as of the date of installation of the erosion amount managing apparatus 18, the preparation threshold has been stored in the arithmetic operation result storage section 64. Further, in the case where the future erosion amount has reached the replacement threshold within the specified future arithmetic operation period in the arithmetic operation of the future erosion amount after the installation of the erosion amount managing apparatus 18, the preparation threshold has been stored in the arithmetic operation result storage section 64.

On the other hand, in the case where the future erosion amount has not reached the replacement threshold within the specified future arithmetic operation period in the arithmetic operation of the future erosion amount as of the date of installation of the erosion amount managing apparatus 18, the preparation threshold has not been stored in the arithmetic operation result storage section 64. Further, in the case where the future erosion amount has not reached the replacement threshold within the specified future arithmetic operation period in the arithmetic operation of the future erosion amount after the installation of the erosion amount managing apparatus 18, the preparation threshold has not been stored in the arithmetic operation result storage section 64.

When determining in the determination of Step S25 that the preparation threshold has not been stored (No at Step S25), the fixed-cycle erosion arithmetic operation section 71 performs the processing at Step S25 again.

When determining in the determination of Step S25 that the preparation threshold has been stored (Yes at Step S25), the fixed-cycle erosion arithmetic operation section 71 determines whether or not the past erosion amount has reached the preparation threshold based on the arithmetic operation result at Step S22 (Step S26).

When determining in the determination of Step S26 that the past erosion amount has not reached the preparation threshold (No at Step S26), the fixed-cycle erosion arithmetic operation section 71 performs the processing at Step S25 again.

When determining in the determination of Step S26 that the past erosion amount has reached the preparation threshold (Yes at Step S26), the fixed-cycle erosion arithmetic operation section 71 determines whether or not the past erosion amount has reached the replacement threshold based on the arithmetic operation result at Step S22 (Step S27).

Here, the case where the past erosion amount reaches the preparation threshold means that the past erosion amount reaches the preparation threshold based on the future prediction calculated by the future erosion arithmetic operation section 72.

When determining in the determination of Step S27 that the past erosion amount has not reached the replacement threshold (No at Step S27), the fixed-cycle erosion arithmetic operation section 71 outputs information on the year, month, and day when the past erosion amount reached the preparation threshold (information related to the recommended preparation time) to the arithmetic operation result storage section 64. The arithmetic operation result storage section 64 stores this information.

The display information generation section 73 generates display information based on the arithmetic operation result stored in the arithmetic operation result storage section 64 and the information stored in the template storage section 65 (Step S28). Then, the display information generation section 73 outputs the generated display information to the display information storage section 66 and the user interface 50. The display information storage section 66 stores the display information.

The user interface 50 updates the display screen based on the display information output from the display information generation section 73 (Step S29). By this update, the information on the recommended preparation time on the alarm display 103 illustrated in FIG. 9 is updated.

When determining in the determination of Step S27 that the past erosion amount has reached the replacement threshold (Yes at Step S27), the fixed-cycle erosion arithmetic operation section 71 outputs information on the year, month, and day when the past erosion amount reached the replacement threshold (information related to the recommended replacement time) to the arithmetic operation result storage section 64. The arithmetic operation result storage section 64 stores the information.

The display information generation section 73 generates display information based on the arithmetic operation result stored in the arithmetic operation result storage section 64 and the information stored in the template storage section 65 (Step S30). Then, the display information generation section 73 outputs the generated display information to the display information storage section 66 and the user interface 50. The display information storage section 66 stores the display information.

The user interface 50 updates the display screen based on the display information output from the display information generation section 73 (Step S31). By this update, the information on the recommended replacement time on the alarm display 103 illustrated in FIG. 9 is updated.

Here, the arithmetic operation of the past erosion amount in the fixed-cycle erosion arithmetic operation section 71 is executed, for example, every hour. Therefore, the information on the past erosion amount on the display screen 100 is updated every hour. Incidentally, when the time range on the horizontal axis is the same, the information on the past erosion amount in the graph 101 in FIG. 9 increases with the passage of time.

By the above-described fixed-cycle erosion arithmetic operation processing, the information on the past erosion amount on the display screen 100 illustrated in FIG. 9 is updated. Further, when the past erosion amount has reached the preparation threshold, or when the past erosion amount has reached the replacement threshold, the information on the alarm display 103 is updated.

### (Future Erosion Arithmetic Operation Processing)

Next, there is explained future erosion arithmetic operation processing in the erosion amount managing apparatus 18 in the first embodiment.

FIG. 11 is a flowchart for explaining a method of the future erosion arithmetic operation processing in the erosion amount managing apparatus 18 in the first embodiment.

Here, as of the date of installation of the erosion amount managing apparatus 18, the future operating conditions illustrated in FIG. 3 have been set initially. After the installation, the user inputs the future operating conditions in units of one year through the input screen 80 illustrated in FIG. 3 in the user interface 50.

For example, by pressing a selection button 105 in a selection display portion 104 on the display screen 100 illustrated in FIG. 9, a selection item of the input screen 80 for future operating conditions is displayed in the selection display portion 104, although not illustrated. When the selection item of the input screen 80 is selected in the selection display portion 104, the screen of the display part of the user interface 50 is switched to the input screen 80 for future operating conditions illustrated in FIG. 3. At this time, the display information generation section 73 receives information related to the selection of the input screen 80 from the user interface 50 and outputs display information for displaying the input screen 80 to the user interface 50.

Then, after inputting the future operating conditions, the user presses the Save button 87 in FIG. 3. The user interface 50 receives input from the Save button 87 and outputs information related to the future operating conditions to the input information storage section 61. The input information storage section 61 stores the information related to the future operating conditions. Incidentally, the Back button 88 on the input screen 80 is a button to be pressed when returning to the display screen 100 without pressing the Save button 87.

Further, the future erosion arithmetic operation section 72 receives information from the user interface 50 in response to the press of the Save button 87, and determines that the future operating conditions have been input.

As illustrated in FIG. 11, the future erosion arithmetic operation section 72 determines whether or not the future operating conditions have been input (Step S40).

When determining in the determination of Step S40 that the future operating conditions have not been input (No at Step S40), the future erosion arithmetic operation section 72 executes the processing at Step S40 again.

When determining in the determination of Step S40 that the future operating conditions have been input (Yes at Step S40), the future erosion arithmetic operation section 72 reads the program for executing the arithmetic operation of the future erosion amount and the arithmetic expressions/equations and parameters for calculating the future erosion amount from the program storage section 63, the design information of the rotor blade to be managed from the input information storage section 61, and the future operating conditions stored in the input information storage section 61 (Step S41).

Then, the future erosion arithmetic operation section 72 refers to the future operating conditions to determine whether or not there is the detailed operation setting mode (Step S42).

When determining in the determination of Step S42 that there is the detailed operation setting mode (Yes at Step S42), the future erosion arithmetic operation section 72 reads the operating time for each classified load under the future operating conditions and the availability factor (Step S43).

Then, the future erosion arithmetic operation section 72 arithmetically operates the future erosion amount using the arithmetic operation method explained with reference to FIG. 6 and outputs the arithmetic operation result to the arithmetic operation result storage section 64 (Step S44). The arithmetic operation result storage section 64 stores the arithmetic operation result.

The display information generation section 73 generates display information based on the arithmetic operation result stored in the arithmetic operation result storage section 64 and the information stored in the template storage section 65 (Step S45). Then, the display information generation section 73 outputs the generated display information to the display information storage section 66 and the user interface 50. The display information storage section 66 stores the display information.

The user interface 50 displays the display information output from the display information generation section 73 on the display part as illustrated in FIG. 9 (Step S46).

Here, the display information generation section 73 outputs the display information based on the arithmetic operation result to the display information storage section 66 and the user interface 50 each time the arithmetic operation processing of the future erosion amount is executed by the future erosion arithmetic operation section 72. Therefore, the graph 101 illustrating the arithmetic operation result regarding the future erosion amount displayed on the display part is updated each time the arithmetic operation processing of the future erosion amount is executed in the future erosion arithmetic operation section 72. In other words, the graph 101 illustrating the arithmetic operation result regarding the future erosion amount is updated each time the information in response to the press of the Save button 87 on the input screen 80 for future operating conditions is received.

Further, after the processing at Step S44, the future erosion arithmetic operation section 72 determines whether or not the future erosion amount has reached the replacement threshold based on the arithmetic operation result at Step S44 (Step S47).

When determining in the determination of Step S47 that the future erosion amount has not reached the replacement threshold (No at Step S47), the future erosion arithmetic operation section 72 outputs information on the recommended replacement time to the arithmetic operation result storage section 64. That is, the future erosion arithmetic operation section 72 outputs information on the fact that there is no recommended replacement time to the arithmetic operation result storage section 64. Here, in the case where a predetermined recommended replacement time has been stored in the arithmetic operation result storage section 64, the arithmetic operation result storage section 64 updates the information on the recommended replacement time to the newly input information on the fact that there is no recommended replacement time and stores the updated information.

The display information generation section 73 generates display information based on the arithmetic operation result stored in the arithmetic operation result storage section 64 and the information stored in the template storage section 65 (Step S48). The display information generation section 73 generates display information in which the alarm display 103 has been deleted from the display screen 100 illustrated in FIG. 9. Further, the display information generation section 73 generates display information in which the line indicating the preparation threshold (two-dot chain line in FIG. 9) has been deleted from the graph 101 on the display screen 100 illustrated in FIG. 9.

Then, the display information generation section 73 outputs the generated display information to the display information storage section 66 and the user interface 50. The display information storage section 66 stores the display information.

The user interface 50 updates the display screen based on the display information output from the display information generation section 73 (Step S49). By this update, the alarm display 103 is deleted from the display screen 100. Further, the line indicating the preparation threshold (two-dot chain line in FIG. 9) is deleted from the graph 101.

When determining in the determination of Step S47 that the future erosion amount has reached the replacement threshold (Yes at Step S47), the future erosion arithmetic operation section 72 calculates the recommended replacement time and the recommended preparation time by the method explained with reference to FIG. 7 and FIG. 8, and outputs the calculation results to the arithmetic operation result storage section 64 (Step S50). The arithmetic operation result storage section 64 stores the recommended replacement time and the recommended preparation time.

Then, the future erosion arithmetic operation section 72 calculates the preparation threshold by the method explained with reference to FIG. 7 and FIG. 8, and outputs the preparation threshold to the arithmetic operation result storage section 64 (Step S51). The arithmetic operation result storage section 64 stores the preparation threshold.

The display information generation section 73 generates display information based on the arithmetic operation result stored in the arithmetic operation result storage section 64 and the information stored in the template storage section 65 (Step S52). The display information generation section 73 generates display information for updating the alarm display 103 and displaying the line of the preparation threshold (two-dot chain line in FIG. 9) in the graph 101 on the display screen 100 illustrated in FIG. 9.

Then, the display information generation section 73 outputs the generated display information to the display information storage section 66 and the user interface 50. The display information storage section 66 stores the display information.

The user interface 50 updates the display screen based on the display information output from the display information generation section 73 (Step S53). By this update, the alarm display 103 including the recommended replacement time and the recommended preparation time based on the current calculation result is displayed on the display screen 100. Further, in the graph 101, the line indicating the preparation threshold (two-dot chain line in FIG. 9) based on the current calculation result is displayed.

The arithmetic operation result of the future erosion amount in the future erosion arithmetic operation section 72 described above is obtained for each one-year cycle set as the future operating condition. That is, the arithmetic operation result in the future erosion arithmetic operation section 72 is obtained in units of one year.

In the future erosion arithmetic operation processing, pieces of the processing at Step S41 to Step S53 are performed repeatedly each time the information in response to the press of the Save button 87 on the input screen 80 for future operating conditions is received. Then, the information on the future erosion amount on the display screen 100 is updated each time the information in response to the press of the Save button 87 on the input screen 80 for future operating conditions is received.

By the future erosion arithmetic operation processing described above, the information on the future erosion amount on the display screen 100 illustrated in FIG. 9 is updated. For example, the information on the future erosion amount illustrated in the graph 101 varies depending on the future operating condition. Further, the recommended replacement time, the recommended preparation time, and the preparation threshold also vary depending on the future operating condition.

According to the erosion amount managing apparatus 18 in the first embodiment described above, the past erosion amount from the past to the present predicted based on the operation data of the actual steam turbine and the future erosion amount predicted based on the assumed future operating condition can be displayed in the graph 101 in chronological order on the display part of the user interface 50. This allows the user to visually confirm the variation in the erosion amount over time.

Further, in the erosion amount managing apparatus 18, lines indicating the replacement threshold and the preparation threshold can be displayed in the graph 101 on the display screen 100. This allows the user to visually confirm the recommended replacement time and the recommended preparation time.

Furthermore, in the erosion amount managing apparatus 18, the recommended replacement time and the recommended preparation time can be displayed on the display screen 100 as the alarm display 103. This allows the user to specifically recognize the recommended replacement time and the recommended preparation time. Then, by specifically recognizing the recommended preparation time, the user can accurately request the manufacture of the rotor blade to be replaced.

In the erosion amount managing apparatus 18, the arithmetic operation result of the future erosion amount based on the operating condition input on the input screen 80 for future operating conditions can be displayed. Therefore, by changing the operating condition on the input screen 80 for future operating conditions, the user can visually confirm the difference in the future erosion amount depending on the operating condition in the graph 101 on the display screen 100. Further, the user can visually confirm the difference between the recommended replacement time and the recommended preparation time depending on the future operating condition on the alarm display 103 on the display screen 100.

### Second Embodiment

In the second embodiment, there is explained another example of the information on the future erosion amount to be displayed on the display part of the user interface 50.

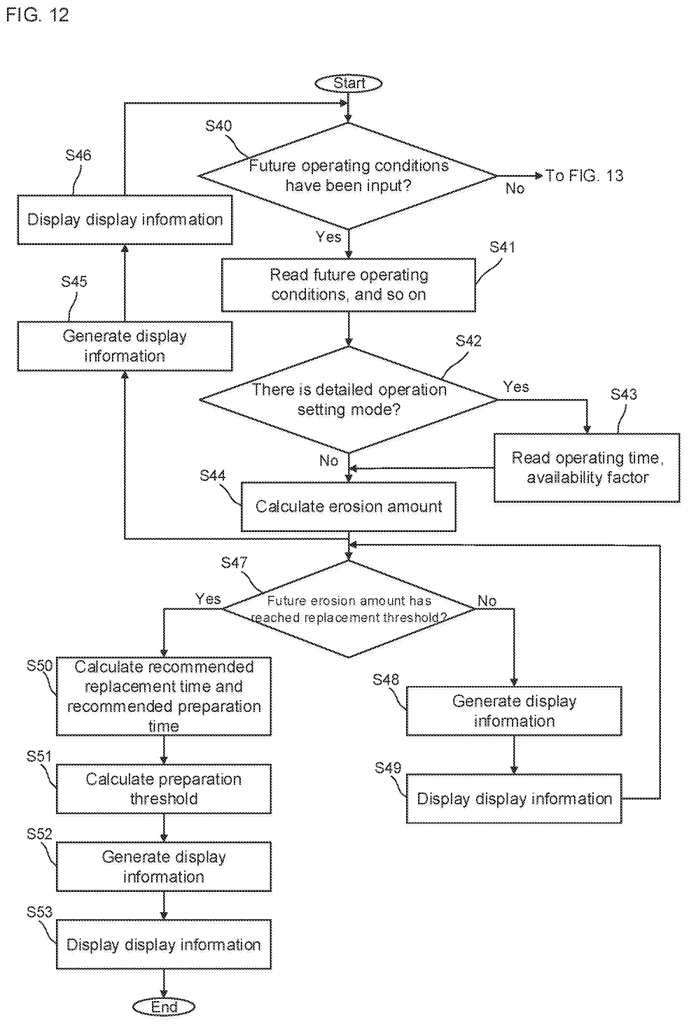

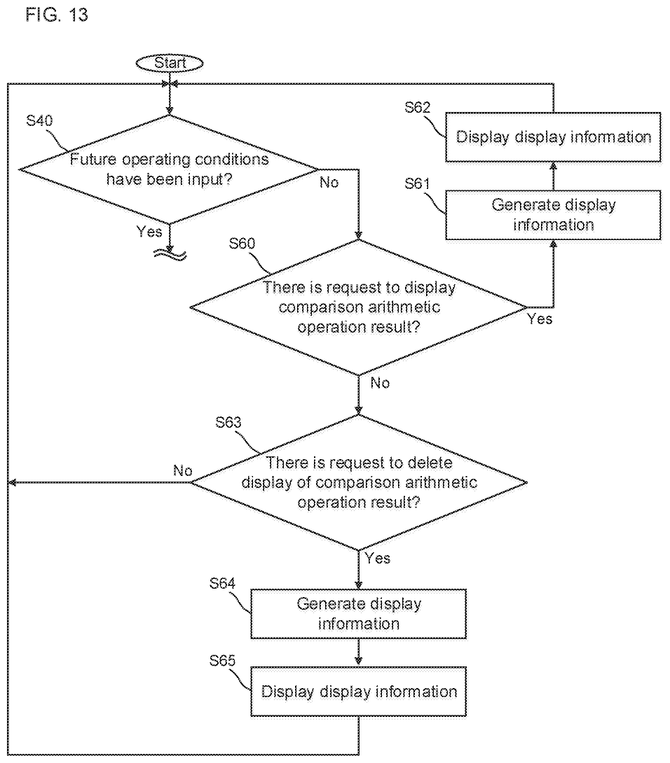

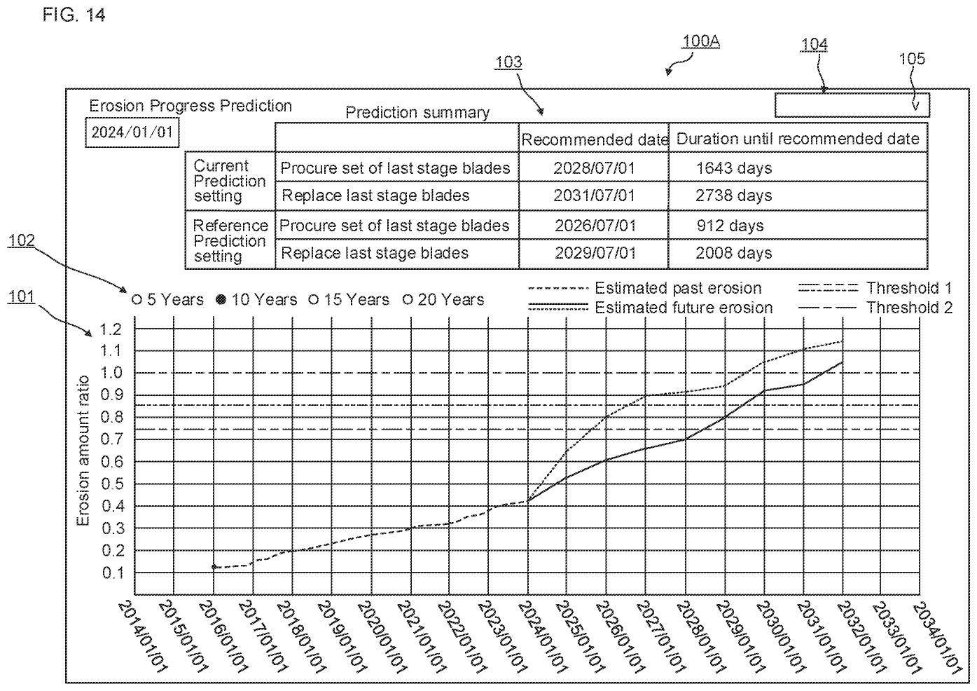

FIG. 12 and FIG. 13 are flowcharts for explaining a method of future erosion arithmetic operation processing in the erosion amount managing apparatus 18 in the second embodiment. Incidentally, the flowchart cannot be illustrated in one diagram due to the formation of the drawing, and thus the flowchart following “No” at Step S40 in FIG. 12 is illustrated in FIG. 13. FIG. 14 is a view illustrating one example of a display screen 100A in the erosion amount managing apparatus 18 in the second embodiment. Incidentally, in the second embodiment, the same reference numerals and symbols are added to the same components as those of the erosion amount managing apparatus 18 in the first embodiment, and redundant explanations are omitted or simplified.

The erosion amount managing apparatus 18 in the second embodiment differs from the erosion amount managing apparatus 18 in the first embodiment in that the arithmetic operation result under another future operating condition can be displayed simultaneously on the display screen 100A, which displays the arithmetic operation result of the erosion amount. Here, this different configuration is mainly explained. Incidentally, the fixed-cycle erosion arithmetic operation processing in the second embodiment is the same as that in the first embodiment.

In the future erosion arithmetic operation processing in the second embodiment illustrated in FIG. 12 and FIG. 13, pieces of processing at Step S60 to Step S65 have been added to the future erosion arithmetic operation processing in the first embodiment.

Here, the user presses the Save button 87 in FIG. 3 after inputting the future operating conditions. In the future erosion arithmetic operation processing in the second embodiment, as in the future erosion arithmetic operation processing in the first embodiment, the user interface 50 receives the input from the Save button 87 and outputs information related to the future operating conditions to the input information storage section 61. The input information storage section 61 stores the information related to the future operating conditions.

Further, the future erosion arithmetic operation section 72 receives information in response to the press of the Save button 87 from the user interface 50, and determines that the future operating conditions have been input.

As illustrated in FIG. 12, the future erosion arithmetic operation section 72 determines whether or not the future operating conditions have been input (Step S40).

When it is determined in the determination of Step S40 that the future operating conditions have been input (Yes at Step S40), pieces of the processing at Step S41 to Step S46 are executed as described previously. Then, as described previously, after the processing at Step S46, the processing at Step S40 is executed.

On the other hand, when it is determined in the determination of Step S40 that the future operating conditions have not been input (No at Step S40), the display information generation section 73 determines whether or not there is a request to display a result obtained by performing the arithmetic operation under another future operating condition (comparison arithmetic operation result) (Step S60), as illustrated in FIG. 13. The comparison arithmetic operation result is an arithmetic operation result that has already been predicted based on another future operating condition, and has been stored in the arithmetic operation result storage section 64. Incidentally, another future operating condition functions as a second future operating condition, and the comparison arithmetic operation result functions as second future erosion amount related information.

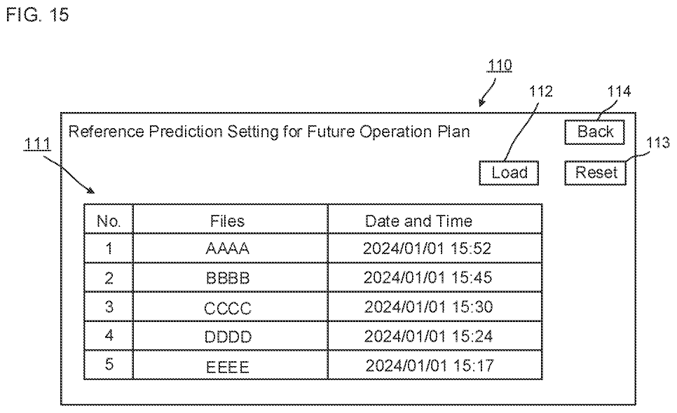

Here, FIG. 15 is a view illustrating one example of a selection screen 110 for selecting the comparison arithmetic operation result to be displayed on the user interface 50 in the erosion amount managing apparatus 18 in the second embodiment.

For example, by pressing the selection button 105 in the selection display portion 104 on the display screen 100 illustrated in FIG. 9, a selection item of the selection screen 110 is displayed in the selection display portion 104, although not illustrated. Then, when the selection item of the selection screen 110 is selected in the selection display portion 104, the screen of the display part of the user interface 50 is switched to the selection screen 110 illustrated in FIG. 15. At this time, the display information generation section 73 receives information related to the selection of the selection screen 110 from the user interface 50 and outputs display information for displaying the selection screen 110 to the user interface 50.

On the selection screen 110 in FIG. 15, a list of already arithmetically operated arithmetic operation results, which are stored in the arithmetic operation result storage section 64, is displayed in a list display portion 111. Further, there has been illustrated one example of the list display portion 111 that also displays dates and times stored in the arithmetic operation result storage section 64 here. In the list display portion 111, for example, file names of five arithmetic operation results are displayed in order of the latest date and time stored in the arithmetic operation result storage section 64. Incidentally, the structure displayed in the list display portion 111 is not limited to this. In the list display portion 111, a list of arithmetic operation results that have already been arithmetically operated only needs to be displayed.

Here, FIG. 15 illustrates one example of comparison arithmetic operation results that were arithmetically operated based on the future operating conditions within the past 1 hour. When these comparison arithmetic operation results are displayed in a graph 101 on the display screen 100A, the comparison arithmetic operation results can be compared without the latest future erosion amount being updated. That is, no matter which of these comparison arithmetic operation results is displayed in the graph 101, the starting point of the line indicating the future erosion amount ratio in the comparison arithmetic operation result coincides with the starting point of the line indicating the latest future erosion amount ratio, as illustrated in FIG. 14.

Incidentally, the comparison arithmetic operation result may be a result arithmetically operated more than one hour ago. For example, when selecting a comparison arithmetic operation result arithmetically operated several days ago, the starting point of the line indicating the future erosion amount ratio in the comparison arithmetic operation result will deviate from the starting point of the line indicating the latest future erosion amount ratio. Even when the respective starting points deviate as above, the variation trends in the erosion amount ratio in the future can be compared.

The user selects the file name of the arithmetic operation result that the user wants to display on the display screen 100 illustrated in FIG. 9 as the comparison arithmetic operation result from the list displayed on the list display portion 111. Then, the user presses a Load button 112. When the user presses the Load button 112, the screen is switched to the display screen 100A to display the arithmetic operation results illustrated in FIG. 14.

Incidentally, a Back button 114 is a button to be pressed when returning to the display screen 100 without pressing the Load button 112 or a Reset button 113.

The display information generation section 73 receives a signal based on the press of the Load button 112 from the user interface 50, and determines at Step S60 that there is a request to display the comparison arithmetic operation result.

When determining in the determination of Step S60 that there is a request to display the comparison arithmetic operation result (Yes at Step S60), the display information generation section 73 generates display information based on the arithmetic operation result stored in the arithmetic operation result storage section 64 and the information stored in the template storage section 65 (Step S61). Here, the display information generation section 73 reads both the arithmetic operation result based on the future operating condition stored in the arithmetic operation result storage section 64 and the selected comparison arithmetic operation result. Then, the display information generation section 73 outputs the generated display information to the display information storage section 66 and the user interface 50. The display information storage section 66 stores the display information.

The user interface 50 displays the display information output from the display information generation section 73 on the display part as illustrated in FIG. 14 (Step S62). As illustrated in FIG. 14, on the display screen 100A, both the arithmetic operation result based on the future operating condition and the comparison arithmetic operation result are displayed as the future erosion amount.

Specifically, as the future erosion amount, the erosion amount ratio in each of the arithmetic operation results is illustrated in chronological order, and at the same time, the line of the preparation threshold in each of the arithmetic operation results is illustrated. Incidentally, the erosion amount ratio in the comparison arithmetic operation result has been illustrated by a dotted line, and the line of the preparation threshold in the comparison arithmetic operation result has been illustrated by a two-dot chain line (two-dot chain line with a narrower interval). Further, as the alarm display 103, the recommended replacement times and the recommended preparation times in the respective arithmetic operation results are displayed. Incidentally, as illustrated in FIG. 14, the erosion amount ratio in the past erosion amount has also been illustrated in chronological order.

Incidentally, the preparation threshold in the comparison arithmetic operation result functions as a second preparation threshold, the recommended replacement time in the comparison arithmetic operation result functions as a second recommended replacement time, and the recommended preparation time in the comparison arithmetic operation result functions as a second recommended preparation time.

When determining in the determination of Step S60 that there is no request to display the comparison arithmetic operation result (No at Step S60), the display information generation section 73 determines whether or not there is a request to delete the display of the comparison arithmetic operation result (Step S63).

Here, the user can delete the comparison arithmetic operation result displayed on the display screen 100A in FIG. 14 by pressing the Reset button 113 on the selection screen 110 in FIG. 15. The display information generation section 73 receives a signal based on the press of the Reset button 113 from the user interface 50, and determines at Step S63 that there is a request to delete the display of the comparison arithmetic operation result. Incidentally, when the user presses the Reset button 113, the screen is switched to the display screen to display the arithmetic operation results.

When determining in the determination of Step S63 that there is a request to delete the display of the comparison arithmetic operation result (Yes at Step S63), the display information generation section 73 generates display information based on the arithmetic operation result stored in the arithmetic operation result storage section 64 and the information stored in the template storage section 65 (Step S64). Here, the display information generation section 73 reads the arithmetic operation result based on the future operating condition stored in the arithmetic operation result storage section 64. Then, the display information generation section 73 outputs the generated display information to the display information storage section 66 and the user interface 50. The display information storage section 66 stores the display information.

The user interface 50 displays the display information output from the display information generation section 73 on the display part as illustrated in FIG. 9 (Step S65). That is, as illustrated in FIG. 9, on the display screen 100, the comparison arithmetic operation result is deleted and only the arithmetic operation results based on the future operating conditions are displayed.

When it is determined in the determination of Step S63 that there is no request to delete the display of the comparison arithmetic operation result (No at Step S63), the operation returns to the processing at Step S40.

Further, as illustrated in FIG. 12, after the processing at Step S44, the future erosion arithmetic operation section 72 determines whether or not the erosion amount has reached the replacement threshold based on the arithmetic operation result at Step S44, as described previously (Step S47). Then, as described previously, pieces of the processing at Step S47 to Step S53 are executed.

The information on the future erosion amount on the display screen 100A is updated each time the information in response to the press of the Save button 87 on the input screen 80 for future operating conditions and the press of the Load button 112 or the Reset button 113 on the selection screen 110 for comparison arithmetic operation results is received.

Incidentally, although there has been explained one example in which one arithmetic operation result is selected as the comparison arithmetic operation result here, the present invention may be set so that a plurality of comparison arithmetic operation results can be selected.

According to the erosion amount managing apparatus 18 in the second embodiment described above, the same operations and effects as those of the erosion amount managing apparatus 18 in the first embodiment can be obtained.

Further, according to the erosion amount managing apparatus 18 in the second embodiment, both the arithmetic operation result predicted based on the future operating condition and the comparison arithmetic operation result can be displayed on the display screen 100A as the future erosion amount.

Thereby, the user can visually confirm the difference between the erosion amount in the arithmetic operation result based on the future operating condition and the erosion amount in the comparison arithmetic operation result in the graph 101 on the display screen 100A. In addition, the user can visually confirm the difference between the recommended replacement time and the recommended preparation time in the arithmetic operation result based on the future operating condition and the recommended replacement time and the recommended preparation time in the comparison arithmetic operation result on the alarm display 103 on the display screen 100A.

According to the embodiments described above, it is possible to recognize in chronological order the erosion amount from the past to the present predicted based on the operation data and the future erosion amount predicted based on the future operating conditions.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A steam turbine rotor blade erosion amount managing apparatus comprising
a display information generation section configured to generate display information for displaying:
past erosion amount related information indicating information on a past erosion amount of a rotor blade of a steam turbine from the past to the present calculated based on measured information; and
future erosion amount related information indicating information on a future erosion amount of the rotor blade calculated based on a future operating condition input via a user interface screen and the past erosion amount related information.

2. The steam turbine rotor blade erosion amount managing apparatus according to claim 1, wherein
the display information generation section generates the display information for displaying both the information on the past erosion amount and the information on the future erosion amount in chronological order.

3. The steam turbine rotor blade erosion amount managing apparatus according to claim 1, wherein
the display information generation section generates the display information for displaying the past erosion amount related information at predetermined time intervals.

4. The steam turbine rotor blade erosion amount managing apparatus according to claim 1, wherein
the display information generation section generates the display information for displaying the future erosion amount related information each time the future operating condition is input.

5. The steam turbine rotor blade erosion amount managing apparatus according to claim 1, wherein
the display information generation section generates the display information for displaying information related to a preparation threshold that is calculated based on the future erosion amount and indicates an erosion amount at which it is recommended to start preparation for a new rotor blade.

6. The steam turbine rotor blade erosion amount managing apparatus according to claim 1, wherein
the display information generation section generates the display information for displaying a recommended preparation time that is calculated based on the future erosion amount and at which it is recommended to start preparation for a new rotor blade.

7. The steam turbine rotor blade erosion amount managing apparatus according to claim 1, wherein
the display information generation section generates the display information for displaying a recommended replacement time that is calculated based on the future erosion amount and at which it is recommended to replace the rotor blade.

8. The steam turbine rotor blade erosion amount managing apparatus according to claim 1, wherein
the display information generation section generates the display information for further displaying second future erosion amount related information indicating information on a second future erosion amount of the rotor blade calculated based on a second future operating condition input via the user interface screen and the past erosion amount related information.

9. The steam turbine rotor blade erosion amount managing apparatus according to claim 8, wherein
the display information generation section generates the display information for displaying information related to a second preparation threshold that is calculated based on the second future erosion amount and indicates an erosion amount at which it is recommended to start preparation for a new rotor blade.

10. The steam turbine rotor blade erosion amount managing apparatus according to claim 8, wherein
the display information generation section generates the display information for displaying a second recommended preparation time that is calculated based on the second future erosion amount and at which it is recommended to start preparation for a new rotor blade.

11. The steam turbine rotor blade erosion amount managing apparatus according to claim 8, wherein
the display information generation section generates the display information for displaying a second recommended replacement time that is calculated based on the second future erosion amount and at which it is recommended to replace the rotor blade.
